(19) United States
(12) Patent Application Publication
(10) Pub. No.: US 2008/0019543 A1
(43) Pub. Date: Jan. 24, 2008

(54) Silicon microphone and manufacturing method therefor

(75) Inventors: Yukitoshi Suzuki, Hamamatsu-shi (JP); Seiji Hirade, Fukuroi-shi (JP); Takahiro Terada, Hamamatsu-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu-shi (JP)

(21) Appl. No.: 11/825,057

(22) Filed: Jul. 3, 2007

(30) Foreign Application Priority Data
Jul. 19, 2006 (JP) 2006-196586
Jul. 27, 2006 (JP) 2006-204299

(51) Int. Cl. H04R 7/06; H04R 31/00

(52) U.S. Cl. 381/174; 29/594

(57) ABSTRACT

In a silicon microphone, a corrugation is formed in a conductive layer between a center portion forming a diaphragm and a periphery, wherein the corrugation is formed on an imaginary line connecting a plurality of supports formed in a circumferential direction of the conductive layer, whereby it is possible to increase the rigidity of the conductive layer; hence, distortion or deformation may hardly occur in the conductive layer irrespective of variations of stress applied thereto. Alternatively, a planar portion is continuously formed on both sides of a step portion in the plate so as to increase its rigidity, wherein a plurality of holes are uniformly formed and arranged in the planar portion by avoiding the step portion. Thus, it is possible to realize a high sensitivity and uniformity of performance and characteristics in the silicon microphone.

### BACKGROUND OF THE INVENTION

1. Field of the Invention

The present invention relates to silicon microphones and condenser microphones, which are constituted of diaphragms and plates positioned opposite to each other. The present invention also relates to manufacturing methods of silicon microphones and condenser microphones.

This application claims priority on Japanese Patent Application No. 2006-204299 and Japanese Patent Application No.:2006-196586, the contents of which are incorporated herein by reference.

2. Description of the Related Art

Conventionally, various types of silicon microphones and condenser microphones have been manufactured in accordance with manufacturing processes of semiconductor devices. It is well known that silicon microphones are constituted of plates and diaphragms that vibrate due to sound waves. In a conventionally-known example of the silicon microphone, a conductive layer forming a diaphragm is supported by a plurality of supports, which are arranged in a circumferential direction of the conductive layer with equal spacing therebetween or which are arranged in a circumferential direction of the conductive layer at random positions. This technology is disclosed in various documents such as Japanese Patent Application Publication No. 2005-535152 and U.S. Pat. No. 5,452,268.

When a diaphragm composed of a conductive layer is supported at plural positions arranged in a circumferential direction thereof, variations occur in internal stress applied to the conductive layer during the manufacturing process. Variations of stress applied to the conductive layer causes stress to be non-uniformly distributed so that an unwanted deformation or distortion occurs in the diaphragm (and the conductive layer). For this reason, irregular vibration may occur in the peripheral portion rather than the center portion of the diaphragm. This makes electrodes, which are positioned opposite to each other with a prescribed gap therebetween, unexpectedly come in contact with each other in certain areas thereof subjected to relatively large vibration. This also causes a reduction of variations of electrostatic capacitance in other areas subjected to relatively small vibration; hence, the sensitivity of a silicon microphone is reduced. Since irregular vibration may tend to occur in the peripheral portion compared with the center portion of the diaphragm, it is very difficult to predict the performance of the silicon microphone in advance.

U.S. Patent Application Publication No. 2005/0241944 teaches a condenser microphone having a bent portion (or a step difference portion) in the periphery of a diaphragm. U.S. Pat. No. 4,776,019 teaches a condenser microphone in which holes are formed in the periphery of a diaphragm.

When a plate is formed above the diaphragm by way of CVD (Chemical Vapor Deposition), the shape of the step difference portion or the shapes of the holes are unexpectedly transferred onto the plate, which has holes allowing sound waves to be transmitted therethrough. In the manufacturing process, the external force applied to the plate and the stress caused by the electrostatic attraction between the plate and the diaphragm may concentrate at the holes of the plate, whereby the plate is likely to be destroyed.

### SUMMARY OF THE INVENTION

It is an object of the present invention to provide a silicon microphone having a high sensitivity and regular performance by reducing distortion of a conductive layer forming a diaphragm and by reducing irregular vibration occurring in the peripheral portion of the conductive layer.

It is another object of the present invention to provide a silicon microphone in which a plate is increased in strength.

In a first aspect of the present invention, a silicon microphone includes a conductive layer whose center portion forms a diaphragm, a plurality of supports that are arranged in a circumferential direction of the conductive layer so as to support the conductive layer, and a corrugation that is formed in the conductive layer and that lies across imaginary lines drawn between the plurality of supports. Due to the formation of the corrugation, it is possible to increase the rigidity of the conductive layer forming the diaphragm, whereby distortion or deformation may hardly occur in the conductive layer irrespective of variations of stress applied thereto. In addition, it is possible to prevent a very large local vibration and a very small local vibration from occurring in the conductive layer; hence, it is possible to prevent an irregular vibration from occurring in the periphery externally of the center portion of the conductive layer forming the diaphragm; thus, it is possible to noticeably improve the sensitivity of the silicon microphone. Furthermore, it is possible to stabilize the vibration of the diaphragm, and it is possible to realize high and regular performance of the silicon microphone.

In the above, the corrugation is connected between the supports, or it is arranged externally of the supports. In addition, the corrugation is formed in a circular shape in a concentric manner with the conductive layer, or it is formed in an arc shape in a concentric manner with the conductive layer. Alternatively, it is possible to form a plurality of corrugations in a radial manner with the conductive layer. Herein, the corrugation is formed by partially reducing the thickness of the conductive layer. Instead of the corrugation, it is possible to form a thick portion in the conductive layer by partially increasing the thickness of the conductive layer.

In a second aspect of the present invention, a condenser microphone includes a support, a plate, which has a plurality of holes and a fixed electrode and which is supported by the support, and a diaphragm, which has a moving electrode positioned opposite to the fixed electrode and which vibrates due to sound waves applied thereto, wherein the plate has a planar portion and a step portion, which differ from each other in thickness, wherein the planar portion is continuously formed on both sides of the step portion, and wherein the holes run through the planar portion of the plate in its thickness direction. Herein, the holes are not formed to lie across the step portion, where the stress of the plate concentrates at; hence, it is possible to increase the rigidity of the plate compared with another plate in which holes lie across the step portion. Thus, it is possible to prevent the plate from being easily destroyed by an external force.

In the above, the holes allowing sound waves to transmit therethrough are uniformly formed and arranged in the planar portion of the plate, thus improving the output characteristics of the condenser microphone. In addition, the holes are aligned along a plurality of lines or along a plurality of circles by avoiding the step portion.

In addition, the diaphragm has a bent portion that is bent in the thickness direction in conformity with the step portion of the plate, so that the bent portion is elongated along the step portion. Alternatively, the diaphragm has a slit so that the step portion of the plate is formed in conformity with an edge of the slit and is elongated along the edge of the slit. Alternatively, the step portion of the plate is formed in conformity with the edge of the diaphragm and is elongated along the edge of the diaphragm. The opening area of each of the holes formed in proximity to the step portion is smaller than the opening area of each of the holes distanced from the step portion. This improves the degree of freedom in arrangement of the holes in the plate; and it is possible to easily arrange the holes such that none of the holes lie across the step portion.

In a manufacturing method of the condenser microphone, the diaphragm having a bent portion, which is bent in the thickness direction, is formed by way of deposition; a sacrifice layer covering the bent portion is formed on the diaphragm by way of deposition; the plate having a planar portion and a step portion is formed on the sacrifice layer by way of deposition, wherein the planar portion is continuously formed on both sides of the step portion, and wherein the step portion is formed in conformity with the bent portion of the diaphragm; the plate is etched so as to form the holes running through the planar portion of the plate in the thickness direction; then, the sacrifice layer is etched so as to form an air gap between the diaphragm and the plate.

Alternatively, the diaphragm is formed by way of deposition; the diaphragm is etched so as to form a slit running through the diaphragm in the thickness direction; a sacrifice layer covering the slit is formed on the diaphragm; the plate having a planar portion and a step portion is formed on the sacrifice layer by way of deposition, wherein the planar portion is continuously formed on both sides of the step portion, and wherein the step portion is formed in conformity with the edge of the slit of the diaphragm; the plate is etched so as to form the holes running through the planar potion in the thickness direction; then, the sacrifice layer is etched so as to form an air gap between the diaphragm and the plate.

Alternatively, the diaphragm is formed by way of deposition; a sacrifice layer covering the edge of the diaphragm is formed by way of deposition; the plate having a planar portion and a step portion is formed on the sacrifice layer by way of deposition, wherein the planar portion is continuously formed on both sides of the step portion, and wherein the step portion is formed in conformity with the edge of the diaphragm; the plate is etched so as to form the holes running through the planar portion of the plate in the thickness direction; then, the sacrifice layer is etched so as to form an air gap between the diaphragm and the plate.

According to the aforementioned manufacturing method, it is possible to manufacture the condenser microphone constituted of the diaphragm and the plate having high rigidity in a simple and easy manner.

### BRIEF DESCRIPTION OF THE DRAWINGS

These and other objects, aspects, and embodiments of the present invention will be described in more detail with reference to the following drawings, in which:

FIG. 1A is a plan view showing the constitution of a silicon microphone in accordance with a first embodiment of the present invention;

FIG. 1B is a cross-sectional view taken along line B-B in FIG. 1A;

FIG. 1C is a cross-sectional view taken along line C-C in FIG. 1A;

FIG. 2A is a cross-sectional view for explaining a first step of a manufacturing method of the silicon microphone;

FIG. 2B is a cross-sectional view for explaining a second step of the manufacturing method of the silicon microphone;.

FIG. 2C is a cross-sectional view for explaining a third step of the manufacturing method of the silicon microphone;

FIG. 2D is a cross-sectional view for explaining a fourth step of the manufacturing method of the silicon microphone;

FIG. 2E is a cross-sectional view for explaining a fifth step of the manufacturing method of the silicon microphone;

FIG. 3A is a cross-sectional view for explaining a sixth step of the manufacturing method of the silicon microphone;

FIG. 3B is a cross-sectional view for explaining a seventh step of the manufacturing method of the silicon microphone;

FIG. 3C is a cross-sectional view for explaining an eighth step of the manufacturing method of the silicon microphone;

FIG. 3D is a cross-sectional view for explaining a ninth step of the manufacturing method of the silicon microphone;

FIG. 4 is an enlarged cross-sectional view in connection with FIG. 3C;

FIG. 5 is a cross-sectional view for explaining a first variation of the first embodiment;

FIG. 6 is a cross-sectional view for explaining a second variation of the first embodiment;

FIG. 7 is a plan view for explaining a third variation of the first embodiment;

FIG. 8 is a plan view for explaining a fourth variation of the first embodiment;

FIG. 9 is a plan view for explaining a fifth variation of the first embodiment;

FIG. 10 is a plan view for explaining a sixth variation of the first embodiment;

FIG. 11 is a cross-sectional view for explaining a seventh variation of the first embodiment;

FIG. 12 is a cross-sectional view for explaining an eighth variation of the first embodiment;

FIG. 13 is a cross-sectional view for explaining a ninth variation of the first embodiment;

FIG. 14A is a plan view showing the constitution of a condenser microphone in accordance with a second embodiment of the present invention;

FIG. 14B is a cross-sectional view taken along line B1-B1 in FIG. 14A;

FIG. 15A is a cross-sectional view for explaining a first step of a manufacturing method of the condenser microphone;

FIG. 15B is a cross-sectional view for explaining a second step of the manufacturing method of the condenser microphone;

FIG. 15C is a cross-sectional view for explaining a third step of the manufacturing method of the condenser microphone;

FIG. 16A is a cross-sectional view for explaining a fourth step of the manufacturing method of the condenser microphone;

FIG. 16B is a cross-sectional view for explaining a fifth step of the manufacturing method of the condenser microphone;

FIG. 16C is a cross-sectional view for explaining a sixth step of the manufacturing method of the condenser microphone;

FIG. 17A is a plan view showing the constitution of a condenser microphone in accordance with a first variation of the second embodiment;

FIG. 17B is a cross-sectional view taken along line B4-B4 in FIG. 17A;

FIG. 18A is a cross-sectional view for explaining a first step of a manufacturing method of the condenser microphone;

FIG. 18B is a cross-sectional view for explaining a second step of the manufacturing method of the condenser microphone;

FIG. 18C is a cross-sectional view for explaining a third step of the manufacturing method of the condenser microphone;

FIG. 19A is a plan view showing the constitution of a condenser microphone in accordance with a second variation of the second embodiment;

FIG. 19B is a cross-sectional view taken along line B6-B6 in FIG. 19A;

FIG. 20A is a plan view for explaining a first step of a manufacturing method of the condenser microphone;

FIG. 20B is a cross-sectional view of FIG. 20A;

FIG. 21A is a plan view for explaining a second step of a manufacturing method of the condenser microphone;

FIG. 21B is a cross-sectional view of FIG. 21A;

FIG. 22A is a plan view for explaining a third step of a manufacturing method of the condenser microphone;

FIG. 22B is a cross-sectional view of FIG. 22A;

FIG. 23A is a plan view showing the constitution of a condenser microphone in accordance with a third variation of the second embodiment;

FIG. 23B is a cross-sectional view taken along line B10-B10 in FIG. 23A;

FIG. 24A is a cross-sectional view for explaining a first step of a manufacturing method of the condenser microphone;

FIG. 24B is a cross-sectional view for explaining a second step of the manufacturing method of the condenser microphone;

FIG. 24C is a cross-sectional view for explaining a third step of the manufacturing method of the condenser microphone;

FIG. 25 is a plan view showing a condenser microphone in accordance with a fourth variation of the second embodiment;

FIG. 26 is a plan view showing a condenser microphone in accordance with a fifth variation of the second embodiment; and

FIG. 27 is a plan view showing a condenser microphone in accordance with a sixth variation of the second embodiment.

### DESCRIPTION OF THE PREFERRED EMBODIMENTS

The present invention will be described in further detail by way of examples with reference to the accompanying drawings.

### 1. First Embodiment

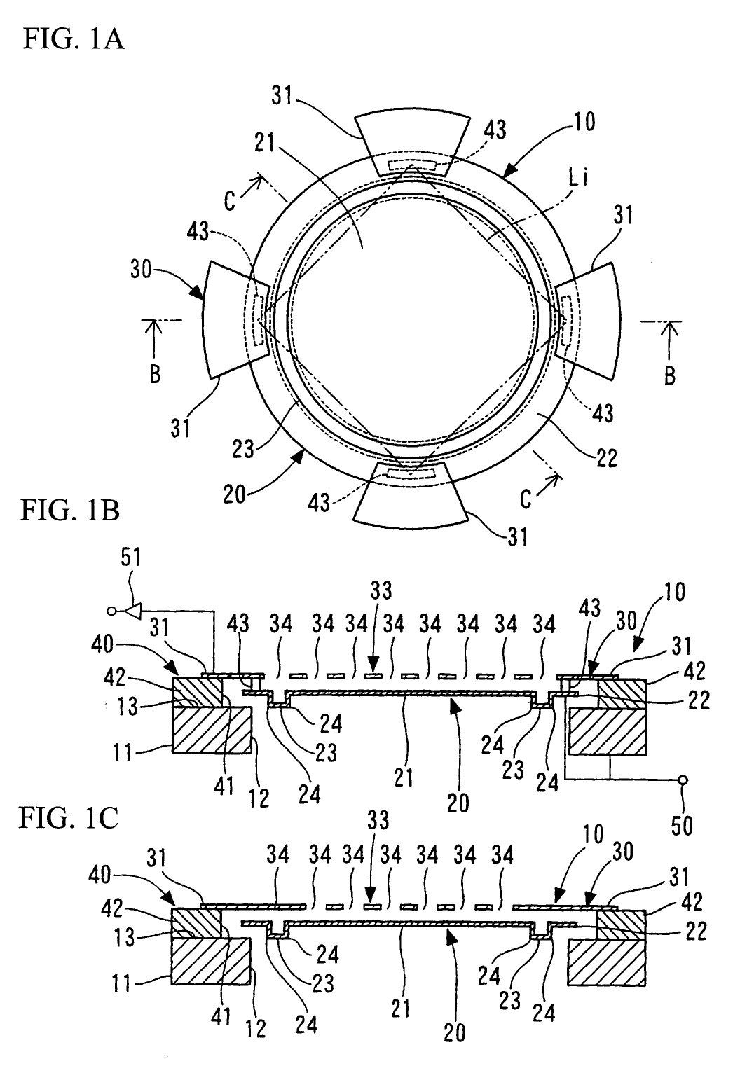

FIGS. 1A to 1C show a silicon microphone 10 in accordance with a first embodiment of the present invention. The silicon microphone 10 is manufactured by way of the semiconductor manufacturing process.

The silicon microphone 10 is constituted of a substrate 11, a first conductive layer 20, a second conductive layer 30, and an insulating layer 40. The substrate 11 is composed of monocrystal silicon, for example. The substrate 11 has a cavity 12 realizing an opening therefor. The cavity 12 runs through the substrate 11 in its thickness direction.

The insulating layer 40 is formed on a surface 13 of the substrate 11. The insulating layer 40 is an oxide layer composed of silicon dioxide, for example. The insulating layer 40 has an opening 41 formed in an interior circumferential portion thereof. The periphery of the opening 41 of the insulating layer 40 forms a support 42 for supporting the second conductive layer 30.

The second conductive layer 30 is formed opposite to the insulating layer 40 with respect to the substrate 11. The second conductive layer 30 is composed of impurities-doped polysilicon, e.g., phosphorus-doped polysilicon. The periphery of the second conductive layer 30 is supported by the support 42 corresponding to the insulating layer 40. The second conductive layer 30 has a plurality of bridges 31, which project inwardly of the support 42. The bridges 31 are arranged in a circumferential direction of the second conductive layer 30. One of each ends of spacers 43 join the bridges 31. The first conductive layer 20 is supported by the other ends of the spacers 43 opposite to the bridges 31. That is, the spacers 43, which are extended from the bridges 31, form a support member for supporting the first conductive layer 20. The spacers 43 support the first conductive layer 20 at plural positions arranged in a circumferential direction of the first conductive layer 20.

The first conductive layer 20 is supported by means of the spacers 43, which are extended from the bridges at plural positions arranged in a circumferential direction thereof. In other words, the first conductive layer 20 is supported downwardly from the bridges 31 corresponding to the second conductive layer 30 by means of the spacers 43. Similar to the second conductive layer 30, the first conductive layer is composed of impurities-doped polysilicon, e.g., phosphorus-doped polysilicon. The first conductive layer 20 has a center portion that lies inwardly of the spacers 43 so as to form a diaphragm 21. The diaphragm 21 vibrates due to sound waves applied thereto. The diaphragm 21, which is formed by means of the first conductive layer 20, has a periphery 22, which lies externally of the center portion thereof.

A plate 33 (i.e., a back plate positioned opposite to the diaphragm 21) is formed by means of a prescribed portion of the second conductive layer 30 lying inwardly of the bridges 31. The plate 33 has a plurality of holes 34, which run through the second conductive layer 30 (forming the plate 33) in its thickness direction. The second conductive layer 30 is electrically insulated from the substrate 11 by means of the insulating layer 40. Similar to the insulating layer 40, the spacers 43 lying between the first conductive layer 20 and the second conductive layer 30 are composed of insulating materials. That is, the first conductive layer 20 is electrically insulated from the second conductive layer 30 by means of the spacers 43. For the sake of convenience, FIG. 1A does not show the plate 33 formed by the second conductive layer 30.

As shown in FIG. 1B, both of the diaphragm 21 and the substrate 11 are connected to a bias voltage source 50. Both of the substrate 11 and the first conductive layer 20 have conductivity, whereby both of the diaphragm 21 and the substrate 11 are set to substantially the same potential. The plate 33 is connected to an input terminal of an operation amplifier 51 having a relatively high input impedance.

When sound waves are transmitted to the diaphragm 21 via the holes 34 of the plate 33, the diaphragm 21 vibrates due to sound waves. The vibration of the diaphragm 21 causes variations of the distance between the diaphragm 21 and the plate 33. The diaphragm 21 and the plate 33 are positioned opposite to each other with an air gap having an insulating property therebetween. Due to variations of the distance between the diaphragm 21 and the plate 33, electrostatic capacitance therebetween varies correspondingly.

Since the plate 33 is connected to the operational amplifier 51 having a relatively high input impedance, very small amounts of electrical charges existing in the plate 33 move toward the operational amplifier 51 irrespective of variations of the electrostatic capacitance between the diaphragm 21 and the plate 33. That is, variations of electrical charges existing in the diaphragm 21 and the plate 33 can be presumed to be negligible. In other words, variations of the electrostatic capacitance between the diaphragm 21 and the plate 33 can be substantially translated into variations of potential of the plate 33. Therefore, the silicon microphone 10 can produce electric signals based on very small variations of potential of the plate 33 due to variations of electrostatic capacitance. In the silicon microphone 10, variations of sound pressure applied to the diaphragm 21 are converted into variations of electrostatic capacitance, which are then converted into potential variations of the plate 33, based on which electric signals are produced in response to sound pressure.

In the silicon microphone 10, a corrugation 23 is formed to realize high rigidity of the first conductive layer 20. The corrugation 23 lies between the center portion of the first conductive layer 20 (forming the diaphragm 21) and the periphery 22 of the first conductive layer 20. Specifically, the corrugation 23 forms a channel between the center portion and the peripheral portion 22 of the first conductive layer 20, wherein it is recessed in a direction opposite to the second conductive layer 30. In the first embodiment, the corrugation 23 is formed continuously in a circumferential direction in a concentric manner with the first conductive layer 20 forming the diaphragm 21. In FIG. 1A, imaginary lines Li are drawn to connect the spacers 43 together, wherein the corrugation 23 lies across the imaginary lines Li. The imaginary lines Li are virtually-drawn straight line segments directly connecting the spacers 43, which are arranged in the circumferential direction of the silicon microphone 10.

Due to the formation of the corrugation 23, a step portion is formed in the thickness direction of the first conductive layer 20, whereby corners 24 are formed in the first conductive layer 20. Specifically, a plurality of corners 24 are aligned along the circumferential portion of the first conductive layer 20 in a direction from the center portion to the circumferential portion of the first conductive layer 20. Due to the formation of the corners 24, which are formed by way of the formation of the corrugation 23, it is possible to increase the rigidity of the first conductive layer 20 at the corrugation 23 in both of a circumferential direction and a radial direction. Since the corrugation 23 is formed across the imaginary lines Li, it is possible to noticeably increase the rigidity of the first conductive layer 20 with respect to both of the center portion (forming the diaphragm 21) and the periphery 22. Due to the improvement of the rigidity of the first conductive layer 20 (which is caused by the formation of the corrugation 23), it becomes difficult for a distortion (or deformation) to occur in the first conductive layer 20 irrespective of variations of stress. That is, it is possible to noticeably reduce the chance of a very large local vibration or a very small local vibration occurring in the first conductive layer 20. As a result, it is possible to noticeably reduce an irregular vibration occurring in the periphery 22, which lies externally of the center portion of the first conductive layer 20 forming the diaphragm 21. This stabilizes the vibration of the first conductive layer 20, whereby it is possible to prevent the first conductive layer 20 from coming in contact with the second conductive layer 30 due to a very large irregular vibration occurring in the periphery 22, and it is possible to prevent the sensitivity of the silicon microphone 10 from being reduced due to the occurrence of a very small vibration in the center portion of the first conductive layer 20 forming the diaphragm 21.

Due to a reduction of a very large irregular vibration occurring in the periphery 22, it is possible to noticeably reduce the chance of the first conductive layer 20 unexpectedly coming in contact with the second conductive layer 30. In other words, it is possible to reduce the distance between the first conductive layer 20 and the second conductive layer 30 in design of the silicon microphone 10. That is, it is possible to reduce the distance between the diaphragm 21 and the plate 33, and it is therefore possible to increase the sensitivity of the silicon microphone 10. Due to the stabilization of the vibration of the first conductive layer 20, it is possible to realize high and regular performance of the silicon microphone 10.

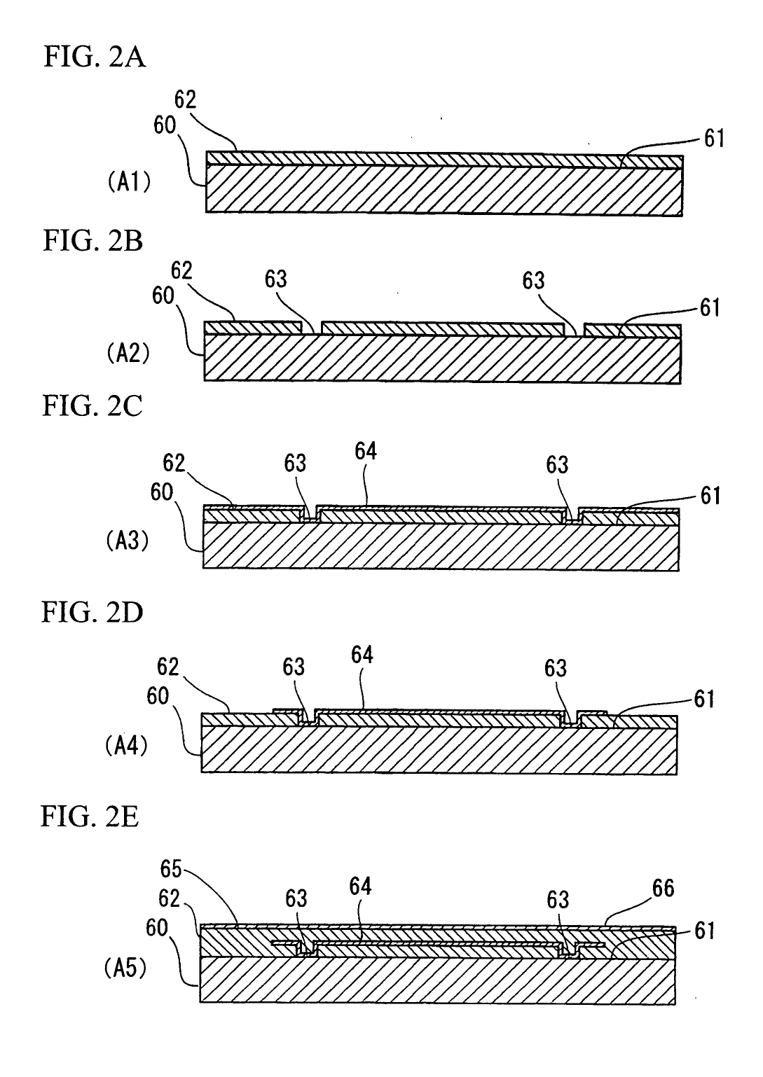

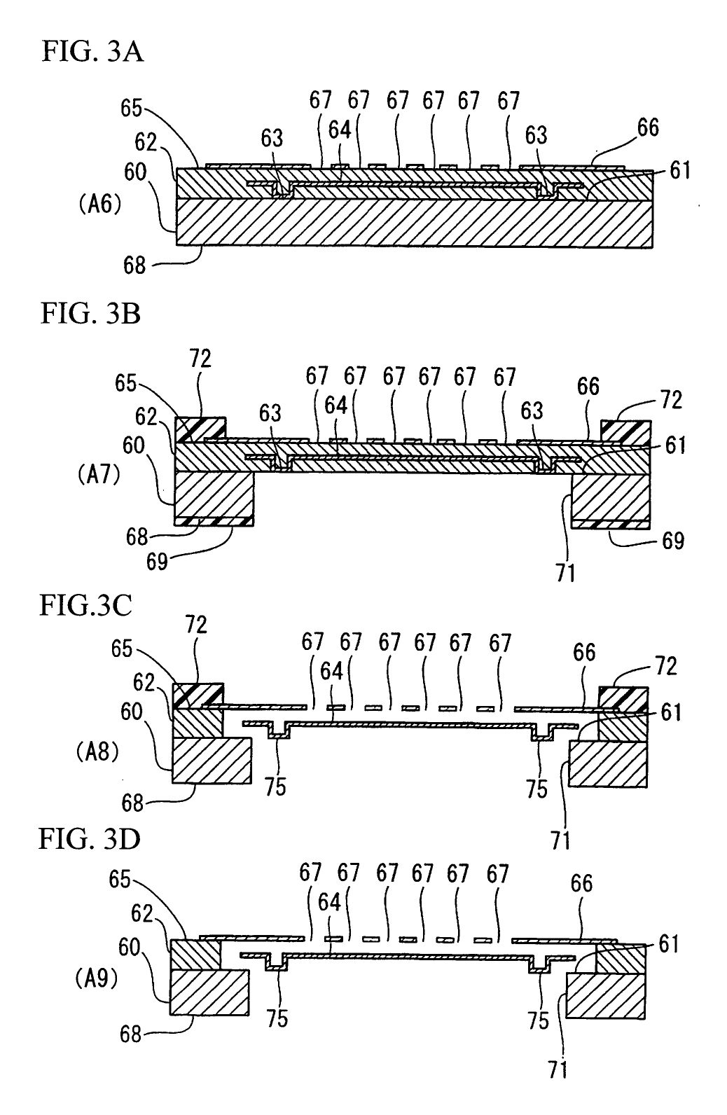

Next, a manufacturing method of the silicon microphone 10 will be described in detail with reference to FIGS. 2A to 2E and FIGS. 3A to 3D.

As shown in FIG. 2A, an oxide layer 62 is formed on a surface 61 of a substrate 60 (composed of silicon) by way of the growth of silicon dioxide. The oxide layer 62 corresponds to the insulating layer 40 shown in FIGS. 1B and 1C. As shown in FIG. 2B, a recess 63 is formed in the oxide layer 62. Specifically, the oxide layer 62 is covered with a resist mask and is then subjected to etching using hydrogen fluoride, thus forming the recess 63. The thickness of the oxide layer 62 substantially matches the depth of the corrugation 23 formed in the first conductive layer 20 shown in FIGS. 1B and 1C. The oxide layer 62 is subjected to etching in such a way that the surface 61 of the substrate 60 is partially exposed in the recess 63.

After completion of etching (by which the recess 63 is formed in the oxide layer 62), as shown in FIG. 2C, a first conductive layer 64 is deposited on the oxide layer 62 and the prescribed portion of the surface 61 of the substrate 60 exposed from the oxide layer 62 by use of polysilicon. The periphery of the first conductive layer 64 is removed by way of patterning as shown in FIG. 2D.

After completion of the patterning of the first conductive layer 64, as shown in FIG. 2E, the oxide layer 62 is further formed on the previously formed portion thereof. In addition, a second conductive layer 66 is deposited on a surface 65 of the oxide layer 62 positioned opposite to the surface 61 of the substrate 60. The further formed oxide layer 62 is formed on the first conductive layer 64 opposite to the substrate 60. Thus, the first conductive layer 64 is embedded in the oxide layer. 62. After completion of adequate growth of the oxide layer 62, the second conductive layer 66 is deposited on the surface 65 of the oxide layer 62 opposite to the substrate 60. Similar to the first conductive layer 64, the second conductive layer 66 is formed by way of polysilicon deposition.

After completion of the formation of the oxide layer 62 and the second conductive layer 6, as shown in FIG. 3A, the second conductive layer 62 is subjected to patterning so as to form recesses 67 corresponding to the holes 34 of the second conductive layer 30 shown in FIGS. 1B and 1C.

After completion of the patterning of the second conductive layer 66, as shown in FIG. 3B, the substrate 60 is subjected to patterning. Specifically, a surface 68 of the substrate 60 is covered with a resist mask 69 and is then subjected to patterning using an anisotropic or isotropic etching solution. Thus, an opening 71 corresponding to the cavity 12 is formed in the substrate 60.

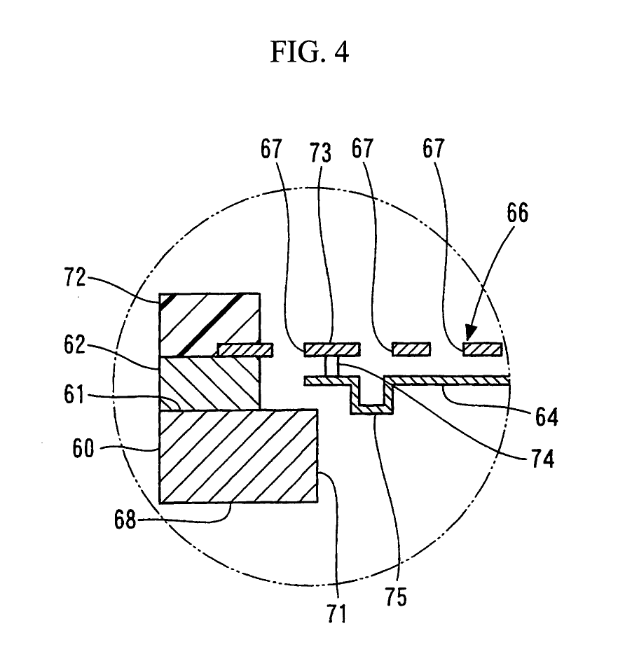

As shown in FIG. 3B, a mask 72 is formed on the second conductive layer 66 so as to cover the prescribed portion of the oxide layer 62 exposed from the second conductive layer 66. Then, the oxide layer 62 is subjected to etching using hydrogen fluoride by way of the recess 67 and the opening 71. Since the periphery of the oxide layer 62 positioned externally of the second conductive layer 66 is covered with the mask 72, the prescribed portion of the oxide layer 62 corresponding to the support 42 is not etched and still remains as it is. As shown in FIG. 4, the widths of remaining portions 73 of the second conductive layer 66, which remain between the holes 34 corresponding to the recesses 67, are appropriately adjusted so that spacers 74, which are formed using the oxide layer 62, are not etched and still remain in proximity to the substrate 60. Thus, the first conductive layer 64 is supported by the spacers 74, which are formed using the oxide layer 62 and which are positioned between the first conductive layer 64 and the second conductive layer 66.

Due to the etching of the oxide layer 62, as shown in FIG. 3C and FIG. 4, the other portion of the oxide layer 62 except for the support 42 and the spacers 43 is removed. In addition, a recess 75 corresponding to the corrugation 23 is formed in the first conductive layer 64. After completion of the etching of the oxide layer 62, as shown in FIG. 3D, the mask 72 is removed.

After the aforementioned manufacturing process, dicing and packaging steps are performed so as to completely produce the silicon microphone 10.

In the silicon microphone 10, the corrugation 23 is formed between the center portion of the first conductive layer 20 forming the diaphragm 21 and the periphery 22. The corrugation 23 lies across the imaginary lines Li connecting between the spacers 43, which are arranged in a circumferential direction, whereby it is possible to noticeably increase the rigidity of the first conductive layer 20 corresponding to the diaphragm 21. Due to the improvement of the rigidity, distortion or deformation may hardly occur in the first conductive layer 20 irrespective of variations of stress applied thereto. That is, it is possible to prevent a very large local vibration and a very small local vibration from occurring in the first conductive layer 20, and it is possible to prevent an irregular vibration from occurring in the periphery 22 positioned externally of the center portion of the first conductive layer 20 corresponding to the diaphragm 21. Therefore, it is possible to stabilize the vibration of the first conductive layer 20, thus improving the sensitivity of the silicon microphone 10. In addition, it is possible to realize high and regular performance of the silicon microphone 10.

The first embodiment can be further modified in a variety of ways; hence, variations of the first embodiment will be described below.

(a) First Variation

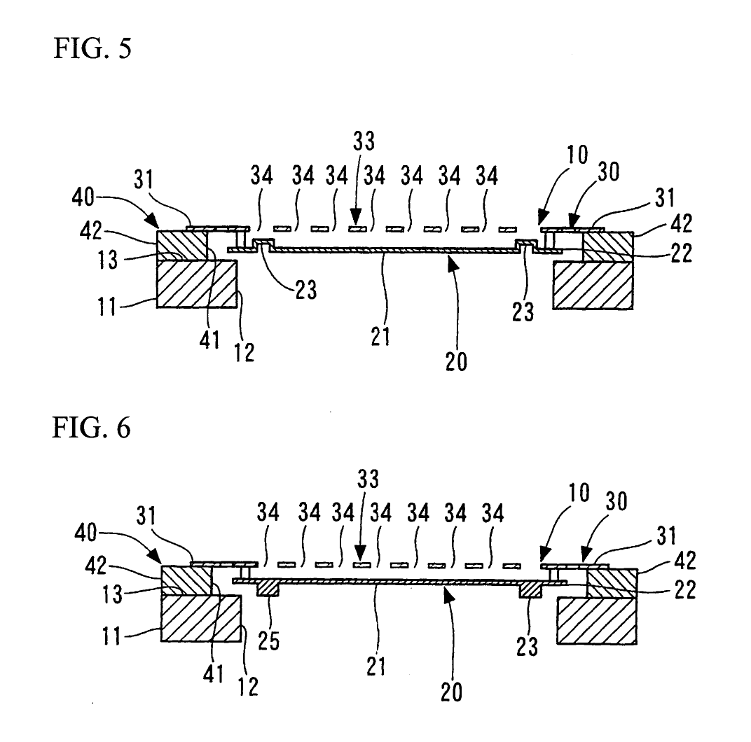

In a first variation of the first embodiment, as shown in FIG. 5, the corrugation 23 of the first conductive layer 20 projects toward the second conductive layer 30. The rigidity of the first conductive layer 20 can be improved irrespective of the projecting direction of the corrugation 23; hence, the corrugation 23 can be formed in such a way that it projects toward the second conductive layer 30.

(b) Second Variation

In a second variation of the first embodiment, as shown in FIG. 6, a thick portion 25 is formed in the first conductive layer 20. Specifically, the thick portion 25 is formed by partially increasing the thickness of the first conductive layer 20. Similar to the corrugation 23, the thick portion 25 increases the rigidity of the first conductive layer 20. In other words, the rigidity of the first conductive layer 20 can be increased using either the corrugation 23 or the thick portion 25.

The first embodiment is described such that, as shown in FIG. 1A, the corrugation 23 lies across the imaginary lines Li connecting between the spacers 43, wherein the corrugation 23 is continuously formed in a circumferential direction of the first conductive layer 20. Herein, it is required that the corrugation 23 be formed to satisfy any one of the following conditions.
(1) The corrugation 23 is formed to lie across the imaginary lines Li connecting the spacers 43 (as described in the first embodiment).
(2) The corrugation 23 is formed on an imaginary line Lii connecting the spacers 43.
(3) The corrugation 23 is formed externally of the spacers 43.

The following variations are designed to suit the aforementioned conditions applied to the corrugation 23.

(c) Third Variation

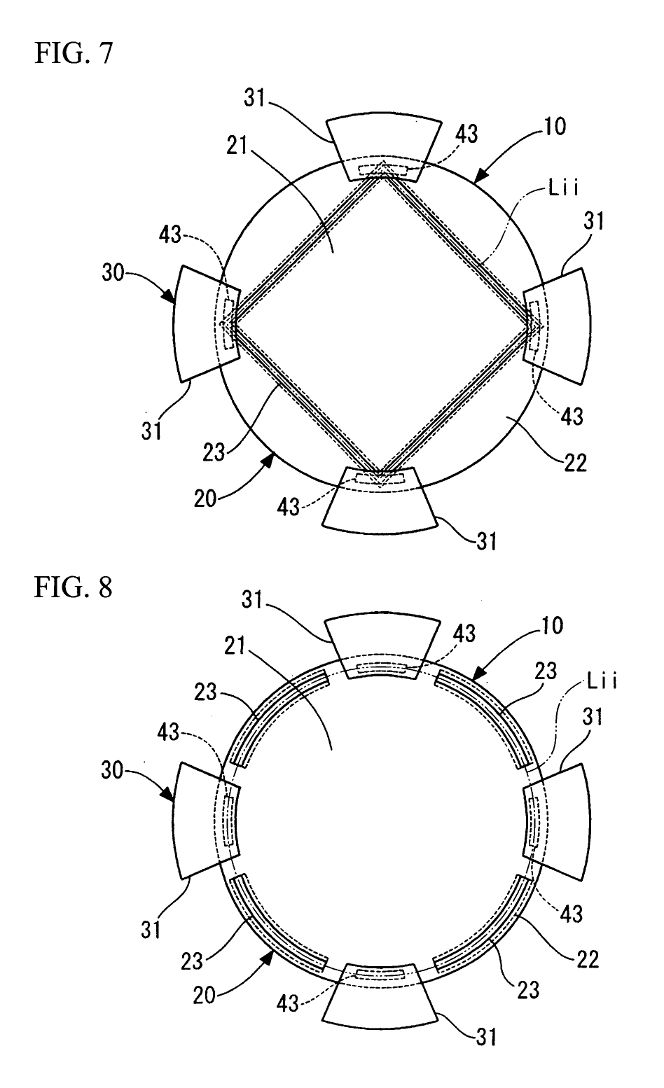

FIG. 7 shows a third variation of the first embodiment, in which the silicon microphone 10 is designed to suit the condition (2). That is, the corrugation 23 is formed on the imaginary line Lii connecting the spacers 43, which are arranged in the circumferential direction of the first conductive layer 20. In the third variation, the corrugation 23 forms straight lines connecting the spacers 43. That is, the corrugation 23 is formed in a square shape whose apexes positionally match the spacers 43.

(d) Fourth Variation

FIG. 8 shows a fourth variation of the first embodiment, in which the silicon microphone 10 is designed to suit the condition (2). That is, the corrugation 23 is formed on the imaginary line Lii connecting the spacers 43, which are arranged in the circumferential direction of the first conductive layer 20. In the fourth variation, the corrugation 23 forms a circle, which is drawn in a concentric manner with the first conductive layer 20 so as to connect between the spacers 43.

According to the third and fourth variations, the corrugation 23 is formed in the first conductive layer 20 so as to connect the spacers 43; hence, it is possible to increase the rigidity of the first conductive layer 20 forming the diaphragm 21. Due to the improvement of the rigidity, distortion or deformation may hardly occur in the first conductive layer 20 irrespective of variations of stress applied thereto. Thus, it is possible to prevent a very large local vibration and a very small local vibration from occurring in the first conductive layer 20, and it is possible to prevent an irregular vibration from occurring in the periphery 22 positioned externally of the center portion of the first conductive layer 20 forming the diaphragm 21. In addition, it is possible to stabilize the vibration of the first conductive layer 20, and it is possible to improve the sensitivity of the silicon microphone 10. Furthermore, it is possible to realize uniformity of performance and characteristics in the silicon microphone 10.

(e) Fifth Variation

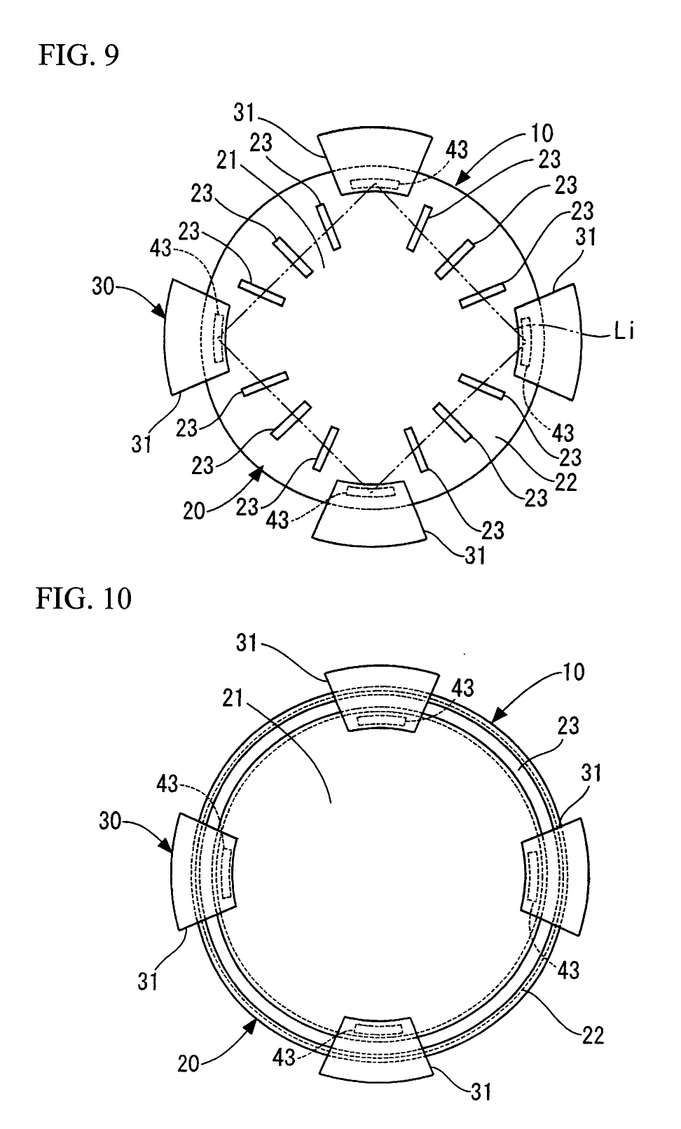

FIG. 9 shows a fifth variation of the first embodiment, in which the silicon microphone 10 is designed to suit the condition (1). That is, a plurality of corrugations 23 are formed to lie across the imaginary lines Li connecting the spacers 43, which are arranged in the circumferential direction of the first conductive layer 20. In the fifth variation, the corrugations 23 are arranged in a radial manner so as to lie across the imaginary lines Li connecting the spacers 43.

Due to the formation of the corrugations 23 that are arranged to lie across the imaginary lines Li connecting the spacers 43, it is possible to increase the rigidity of the first conductive layer 20 forming the diaphragm 21. Similar to the first embodiment, it is possible to stabilize the vibration of the first conductive layer 20, and it is possible to improve the sensitivity of the silicon microphone 10. In addition, it is possible to realize uniformity of performance and characteristics in the silicon microphone 10.

In the fifth variation, three corrugations 23 are arranged in a radial manner between two spacers 43. Herein, it is possible to freely determine the number and angle of the corrugations 23 in accordance with characteristics of the silicon microphone 10.

(f) Sixth Variation

FIG. 10 shows a sixth variation of the first embodiment, in which the silicon microphone 10 is designed to suit the condition (3). That is, the corrugation 23 is formed externally of the spacers 43, which are arranged in the circumferential direction of the first conductive layer 20. In the sixth variation, the corrugation 23 is arranged externally of the spacers 43 in a concentric manner with the first conductive layer 20. Herein, the corrugation 23 is continuously formed in a circle externally of the spacers 43.

Due to the formation of the corrugation 23 externally of the spacers 43, it is possible to increase the rigidity of the first conductive layer 20 forming the diaphragm 21, whereby distortion or deformation may hardly occur in the first conductive layer 20 irrespective of variations of stress applied thereto. Thus, it is possible to prevent a very large local vibration and a very small local vibration from occurring in the first conductive layer 20, and it is possible to prevent an irregular vibration from occurring in the periphery 22 positioned externally of the center portion of the first conductive layer 20 forming the diaphragm 21. In addition, it is possible to stabilize the vibration of the first conductive layer 20, and it is possible to improve the sensitivity of the silicon microphone 10. Furthermore, it is possible to realize uniformity of performance and characteristics in the silicon microphone 10.

In the first embodiment and the aforementioned variations, the first conductive layer 20 forming the diaphragm 21 is supported by the spacers 43 extended from the second conductive layer 30; but this is not a restriction. That is, the support structure adapted to the first conductive layer 20 is not necessarily limited to the use of the spacers 43. The following variations are designed to modify the support structure adapted to the first conductive layer 20.

(g) Seventh Variation

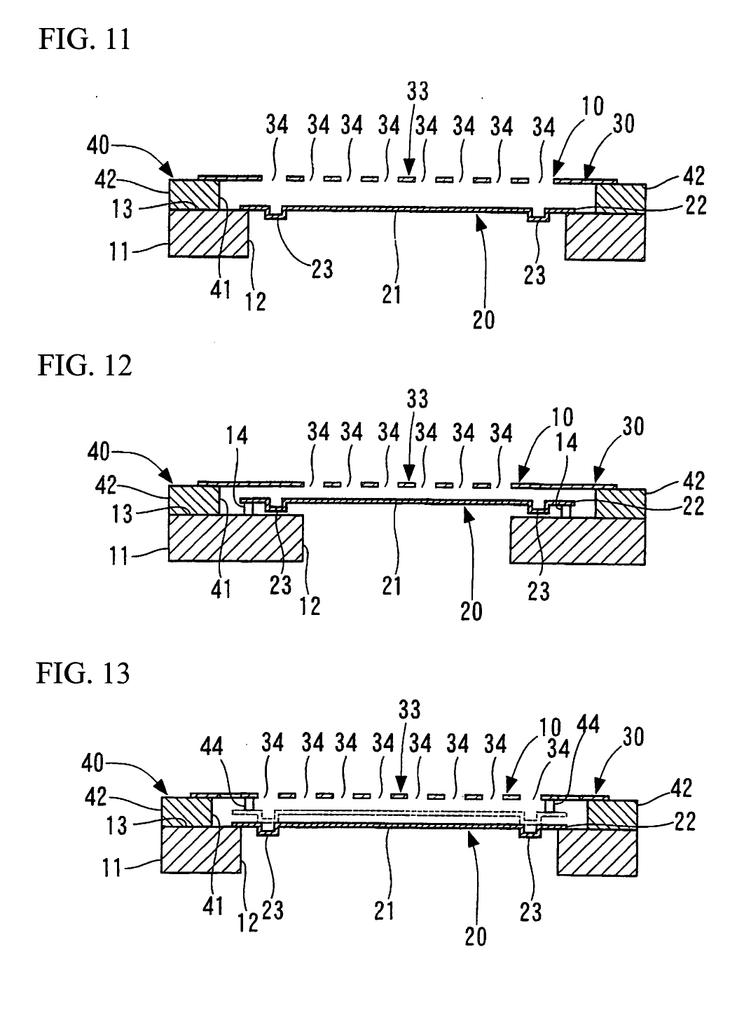

FIG. 11 shows a seventh variation of the first embodiment, in which the first conductive layer 20 forming the diaphragm 21 is supported by the substrate 11. That is, the substrate 11 having the cavity 12 serves as the support structure for supporting the first conductive layer 20.

(h) Eighth Variation

FIG. 12 shows an eighth variation of the first embodiment, in which the first conductive layer 20 forming the diaphragm 21 is supported by means of a support 14 that projects from the substrate 11.

(i) Ninth Variation

FIG. 13 shows a ninth variation of the first embodiment, in which the first conductive layer 20 forming the diaphragm 21 is movable toward the second conductive layer 30. In the silicon microphone 10 of FIG. 13, when the first conductive layer 20 and the second conductive layer 30 are electrified, the first conductive layer 20 moves toward the second conductive layer 30 due to electrostatic attraction exerted therebetween. The movement of the first conductive layer 20 is restricted by means of spacers 44, which project from the second conductive layer 30 and which the first conductive layer 20 comes in contact with. Due to electrification, the first conductive layer 20 (forming the diaphragm 21) moves toward the second conductive layer 30, wherein the spacers 44 serve as the support structure for supporting the first conductive layer 20.

In the first embodiment and first to sixth variations, four spacers 43 are arranged in the circumferential direction between the first conductive layer 20 and the second conductive layer 30. The number of the spacers 23 is not necessarily limited to four; that is, at least two spacers 23 meet the requirement of the first embodiment.

In addition, the first conductive layer 20 (forming the diaphragm 21) and the second conductive layer 30 (forming the plate 33) are not necessarily formed in a circular shape. That is, it can be formed in other shapes such as an elliptical shape, a rectangular shape, and a polygonal shape.

Moreover, the silicon microphone 10 is not necessarily designed in accordance with each of the aforementioned examples; that is, it can be designed based on an appropriate combination of the aforementioned examples.

### 2. Second Embodiment

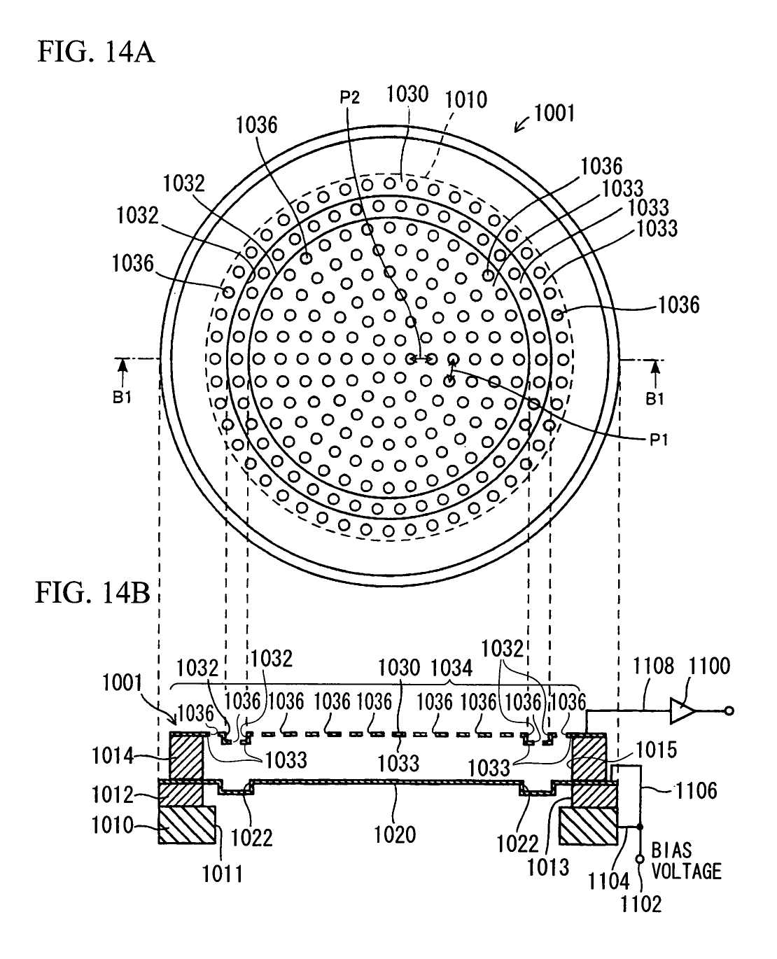

With reference to FIGS. 14A and 14B, a condenser microphone 1001 will be described in detail in accordance with a second embodiment of the present invention, wherein the condenser microphone 1001 is a silicon microphone manufactured by way of the semiconductor manufacturing process. The condenser microphone 1001 converts sound waves transmitted via a plate 1030 into electric signals.

A sensing portion of the condenser microphone 1001 includes a substrate 1010 and first, second, third, and fourth films, which are laminated together.

The substrate 1010 is composed of monocrystal silicon. The substrate 1010 has a cavity 1011 for releasing pressure that is applied to a diaphragm 1020 in a direction opposite to the propagation direction of sound waves.

The first film is an insulating thin film composed of silicon dioxide. A first support 1012 is formed by use of the first film so as to support the second film above the substrate 1010 in such a way that an air gap, is formed between the diaphragm 1020 and the substrate 1010. The first film has a circular opening 1013.

The second film is a conductive thin film composed of impurities-doped polysilicon (e.g., phosphorus-doped polysilicon). The diaphragm 1020 is formed using the prescribed portion of the second film that is not fixed to the first film. The diaphragm 1020 is not fixed to both of the first and third films, and it serves as a moving electrode that vibrate due to sound waves. The diaphragm 1020 has a circular shape covering the cavity 1011. A bent portion 1022, which is bent in the thickness direction, is formed in the periphery of the diaphragm 1020. The bent portion 1022 is formed in the entire circumferential periphery externally of the center portion corresponding to the diaphragm 1020.

Similar to the first film, the third film is an insulating thin film composed of silicon dioxide. The third film forms a second support 1014, which provides insulation between the second and fourth films both having conductivity and which supports the fourth film above the second film. The third film has a circular opening 1015.

The fourth film is a conductive thin film composed of impurities-doped polysilicon (e.g., phosphorus-doped polysilicon). The plate 1030 is formed using the prescribed portion of the fourth film that is not fixed to the third film. The plate has a step portion 1032 and a planar portion 1033. The height difference of the step portion 1032 substantially corresponds to the height difference of the bent portion 1022, wherein the step portion 1032 has a circular shape elongated along the bent portion 1022. The planar portion 1033 is continuously formed on both sides of the step portion 1032.

The plate 1030 has a through-hole pattern 1034 including a plurality of holes 1036 arranged in a concentric manner. The holes 1036 arranged on the same circle are formed in a circumferential direction with equal spacing therebetween (see P1 in FIG. 14A). The same distance (see P2 in FIG. 14A) is formed between adjacent circles along which the holes 1036 are aligned and is determined in such a way that the holes 1036 do not lie across the step portion 1032. In short, the holes 1036 are uniformly distributed and formed in the planar portion 1033 of the plate 1030 while avoiding the step portion 1032. In other words, the holes 1036 are regularly arranged in such a way that none of the holes 1036 lie across the step portion 1032 so as to communicate both sides of the planar portion 1033.

As shown in FIG. 14B, the condenser microphone 1001 has a detecting portion (realized by electric circuitry), in which the diaphragm 1020 is connected to a bias voltage source having leads 1104 and 1106. Specifically, the lead 1104 is connected to the substrate 1010, and the lead 1106 is connected to the second film, whereby both of the diaphragm 1020 and the substrate 1010 are substantially set to the same potential. The plate 1030 is connected to an input terminal of an operation amplifier 1100. Specifically, a lead 1108 connected to the input terminal of the operational amplifier 1100 is connected to the fourth film. The operational amplifier 1100 has a high input impedance.

Next, the operation of the condenser microphone 1001 will be described. When sound waves are transmitted to the diaphragm 1020 via the holes 1036 of the plate 1030, the diaphragm 1020 vibrates due to sound waves so that the distance between the diaphragm 1020 and the plate 1030 varies so as to cause variations of electrostatic capacitance therebetween.

Since the plate 1030 is connected to the operational amplifier 1100 having a high input impedance, even when variations occurs in the electrostatic capacitance between the diaphragm 1020 and the plate 1030, very small amounts of electric charges existing in the plate 1030 move toward the operational amplifier 1100. That is, it is presumed that substantially no variations occur in electric charges existing in the plate 1030 and the diaphragm 1020. This makes it possible to convert variations of electrostatic capacitance into potential variations of the plate 1030. Therefore, the condenser microphone 1001 can produce electric signals in response to very small variations of electrostatic capacitance between the diaphragm 1020 and the plate 1030. In other words, in the condenser microphone 1001, variations of sound pressure applied to the diaphragm 1020 are converted into variations of electrostatic capacitance, which are then converted into potential variations, based on which electric signals are produced in response to variations of sound pressure.

Next, a manufacturing method of the condenser microphone 1001 will be described in detail.

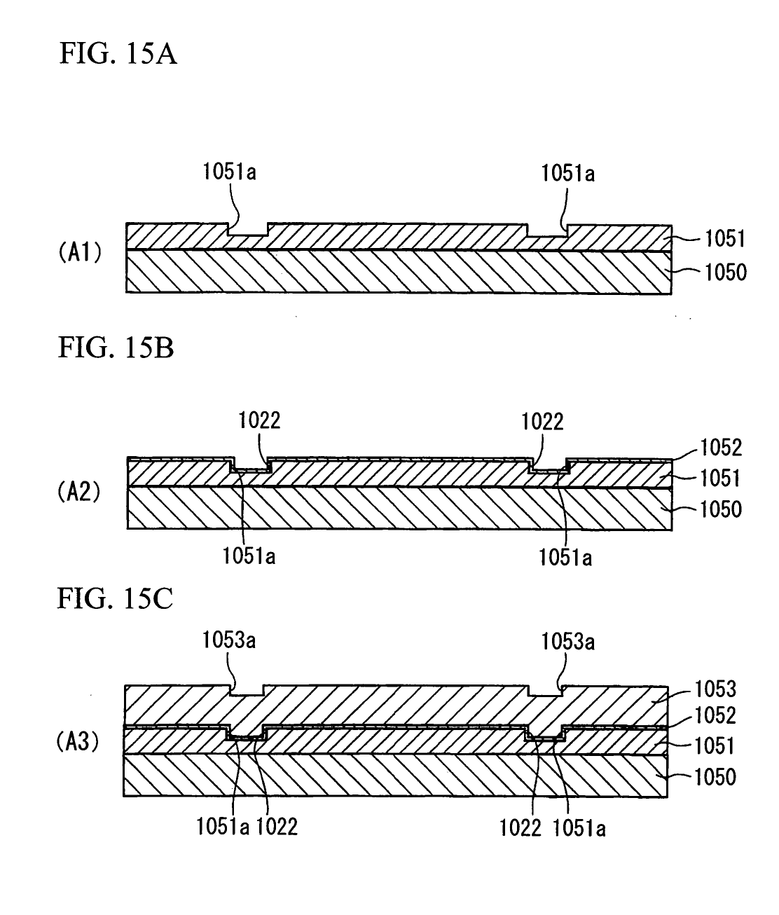

First, as shown in FIG. 15A, a first film 1051 is deposited on a wafer 1050 corresponding to the substrate 1010 shown in FIGS. 14A and 14B. The first film 1051 is subjected to etching so as to form a ring-shaped recess 1051a. Specifically, silicon dioxide is deposited on the wafer 1050 composed of monocrystal silicon by way of plasma CVD, thus forming the first film 1051. Next, a photoresist film is applied to the entire surface of the first film 1051; then, a resist pattern is formed by way of photolithography, in which exposure and development are performed using a prescribed resist mask; thereafter, the first film 1051 is selectively removed by way of anisotropic etching such as RIE (Reactive Ion Etching), thus forming the ring-shaped recess 105 la in the first film 1051.

Next, as shown in FIG. 15B, a second film 1052 is deposited on the first film 1051. Specifically, phosphorus-doped polysilicon is deposited on the first film 1051 by way of decompression CVD, thus forming the second film 1052. A bent portion 1022 whose shape substantially matches the shape of the recess 1051a of the first film 1051 is formed in the second film 1052.

Next, as shown in FIG. 15C, a third film 1053 is deposited on the second film 1052. Specifically, silicon dioxide is deposited on the second film 1052 by way of plasma CVD, thus forming the third film 1052. A recess 1053a whose shape substantially matches the shape of the bent portion 1022 of the second film 1052 is formed in the third film 1053.

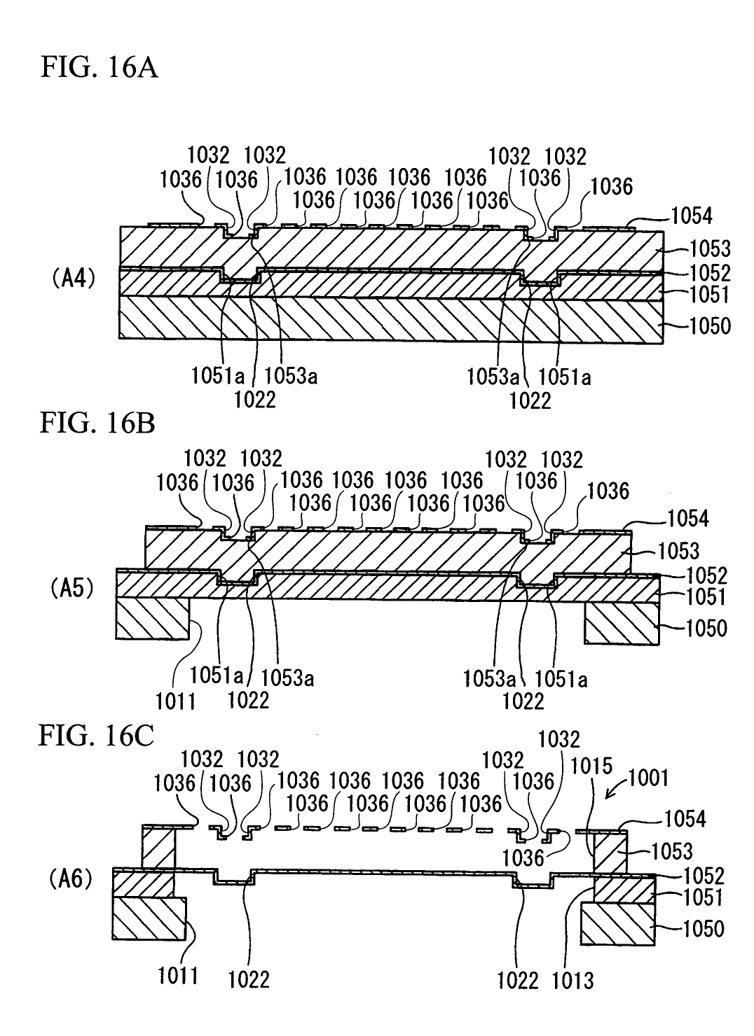

Next, as shown in FIG. 16A, a fourth film 1054 having the through-hole pattern 1034 is deposited on the third film 1053. Specifically, phosphorus-doped polysilicon is deposited on the third film 1053 by way of decompression CVD, thus forming the fourth film 1054. As a result, the step portion 1032 whose shape substantially matches the shape of the recess 1053a of the third film 1053 is formed in the fourth film 1054 above the bent portion 1022 of the second film 1052. In addition, a planar portion is continuously formed on both sides of the step portion 1032 of the fourth film 1054.

Next, the fourth film 1054 is subjected to etching so that a plurality of holes 1036 are formed in the planar portion of the fourth film 1054. Specifically, a photoresist film is applied to the entire surface of the fourth film 1054; then, a resist pattern is formed by way of photolithography, in which exposure and development are performed using a resist mask; thereafter, the fourth film 1054 is selectively removed by way of anisotropic etching such as RIE.

Next, as shown in FIG. 16B, the cavity 1011 is formed in the wafer 1050. Specifically, a photoresist film is applied to the entire backside of the wafer 1050; then, a resist pattern is formed by way of photolithography, in which exposure and development are performed using a resist mask; thereafter, the wafer 1050 is selectively removed by way of anisotropic etching such as Deep RIE, thus forming the cavity 1011 in the wafer 1050.

Next, as shown in FIG. 16C, the first film 1051 and the third film 1053 are selectively removed so as to form openings 1013 and 1015, by which the second film 1052 is exposed from the third film 1053. Specifically, a photoresist film is applied to the entire surface of the third film 1053 and the entire surface of the fourth film 1054; then, a resist pattern having openings for exposing the through-hole pattern 1034 is formed by way of photolithography, in which exposure and development are performed using a resist mask. Next, by way of isotropic wet etching (using an etching solution such as buffered hydrofluoric acid (or buffered HF) or by way of a combination of isotropic etching and anisotropic etching, the first film 1051 and the third film 1053, both of which are silicon oxide films, are selectively removed. At this time, the etching solution is infiltrated via the holes 1036 of the fourth film 1054 and the cavity 1011 of the substrate 1010 so as to dissolve the first film 1051 and the third film 1053. By appropriately designing the through-hole pattern 1034 and the cavity 1011, the openings 1013 and 1015 are formed in the first film 1051 and the third film 1053, respectively. As a result, the sensing portion of the condenser microphone 1001 is constituted of the diaphragm 1020, the plate 1030, the first support 1012, and the second support 1014 (see FIG. 14B).

Thereafter, the condenser microphone 1001 is completely produced by way of dicing and packaging processes.

The second embodiment is not necessarily limited to the aforementioned condenser microphone 1001; hence, it can be modified in a variety of ways as long as the sensing portion has a laminated structure.

(a) First Variation

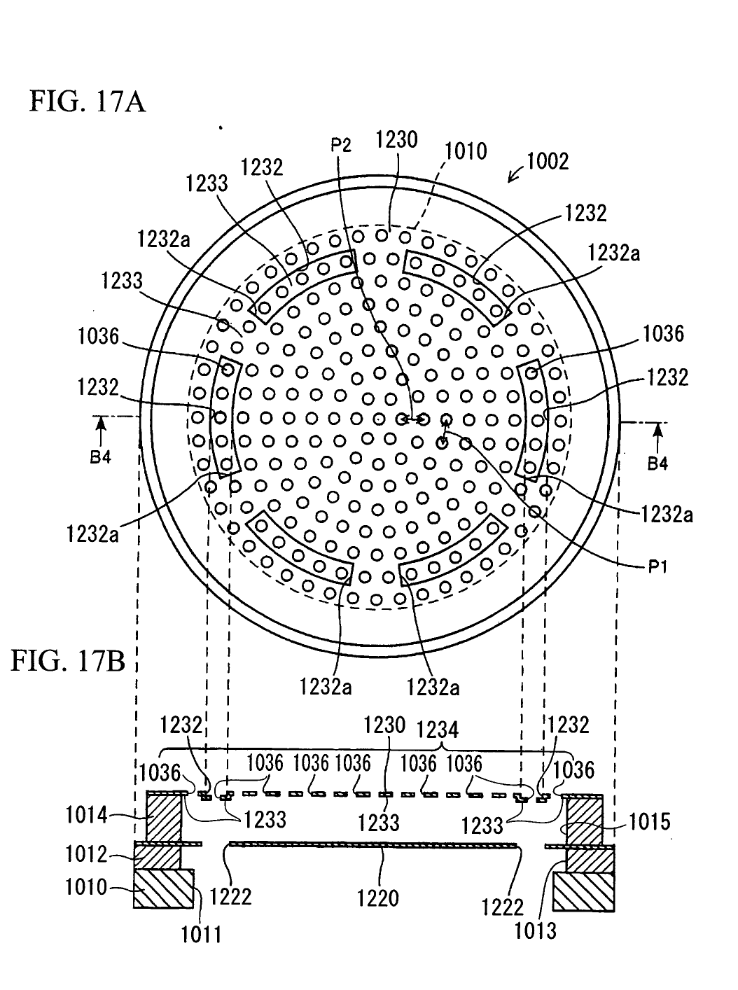

A condenser microphone 1002 according to a first variation of the second embodiment will be described with reference to FIGS. 17A and 17B. The condenser microphone 1002 is constituted of a diaphragm 1220 and a plate 1230, which differ from the diaphragm 1020 and the plate 1030 shown in FIGS. 14A and 14B. A slit 1222 is formed in the periphery of the diaphragm 1220 so as to surround the center portion.

The plate 1230 has a step portion 1232 and a planar portion 1233. The stage portion 1232 is elongated along the edges of the slit 1222 so that the height difference thereof substantially matches the depth of the slit 1222. The planar portion 1233 is continuously formed on both sides of the step portion 1232. The plate 1230 has a through-hole pattern 1234, which is similar to the through-hole pattern 1034, and includes a plurality of holes 1036 aligned in a concentric manner. Herein, the distance P1 between the adjacent holes 1036 aligned on the same circle is determined in such a way that the holes 1036 are not each positioned at an extended portion 1232a of the step portion 1232 extended in a radial direction. That is, the holes 1036 are uniformly distributed and positioned in the planar portion 1233 of the plate 1230 by avoiding the step portion 1232.

The detecting portion of the condenser microphone 1002 is substantially identical to that of the condenser microphone 1001; hence, the description thereof is omitted.

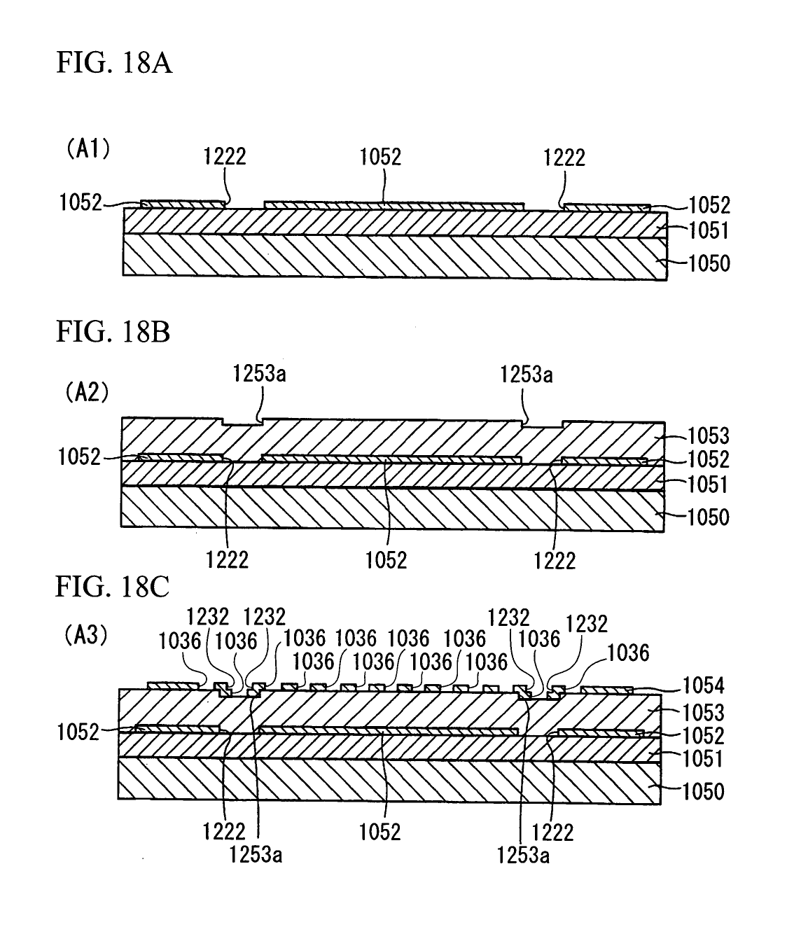

Next, a manufacturing method of the condenser microphone 1002 will be described with reference to FIGS. 18A to 18C. First, as shown in FIG. 18A, the first film 1051 and the second film 1052 are formed on the wafer 1050. The second film 1052 is subjected to etching so as to form the slit 1222 therein.

Next, as shown in FIG. 18B, the third film 1053 is deposited on the first film 1051 and the second film 1052. A recess 1253a whose shape substantially matches the shape of the slit 1222 of the second film 1052 is formed in the third film 1053.

Next, as shown in FIG. 18C, the fourth film 1054 is deposited on the third film 1053. As a result, the stop portion 1232 whose shape substantially matches the shape of the recess 1253a of the third film 1053 is formed above the slit 1222 of the fourth film 1054. The planar portion is continuously formed on both sides of the step portion 1232 of the fourth film 1054.

Next, the fourth film is subjected to etching so as to form a plurality of holes 1036 in the planar portion of the fourth film 1054. Thereafter, the foregoing steps described in relation to the second embodiment are performed, thus completely producing the condenser microphone 1002.

(b) Second Variation

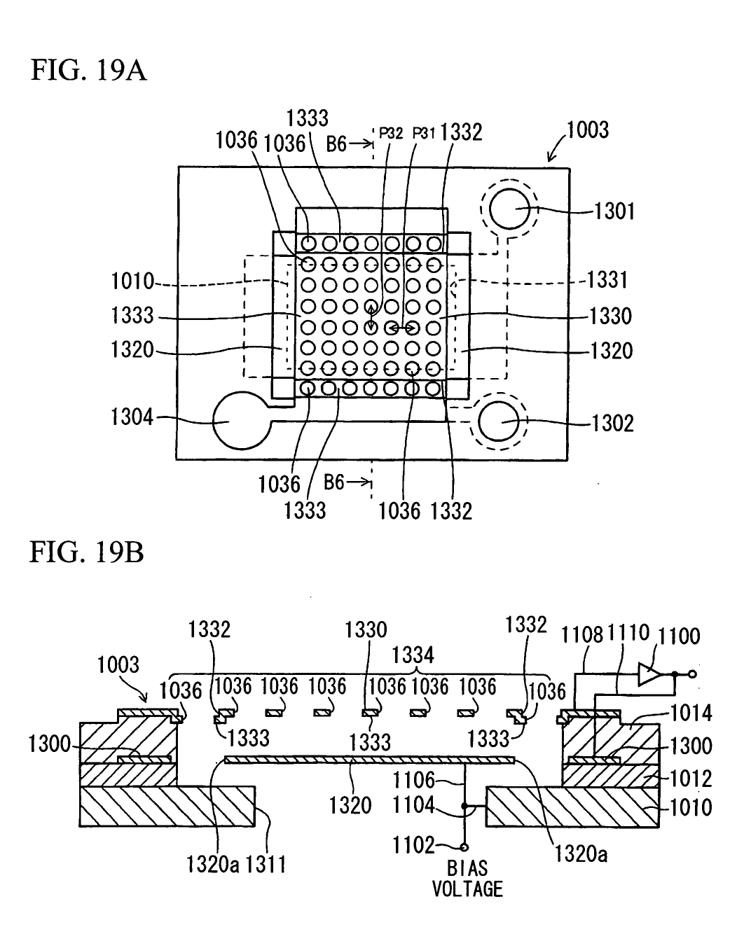

A condenser microphone 1003 according to a second variation of the second embodiment will be described with reference to FIGS. 19A and 19B. The condenser microphone 1003 includes a diaphragm 1320, a plate 1330, and a cavity 1311, which differ from the diaphragm 1020, the plate 1030, and the cavity 1011 included in the condenser microphone 1001. The diaphragm 1320 three-dimensionally crosses the plate 1330 above the cavity 1311. The diaphragm 1320 is formed using a square-shaped second film, and the plate 1330 is formed using a square-shaped fourth film whose longitudinal direction crosses at a right angle with the longitudinal direction of the second film. The plate 1330 includes a step portion 1332 and a planar portion 1333. The step portion 1332 is shaped to suit an edge 1320a of the diaphragm 1320 so that the height difference thereof is substantially determined in response to the edge 1320, wherein the step portion 1332 is extended along the edge 1320a from one end to another end in a short-side direction of the plate 1330. The planar portion 1333 is continuously formed on both sides of the step portion 1332.

A guard electrode 1300 is formed using the second film and is positioned on both sides of the diaphragm 1320 in its short-side direction. The guard electrode 1300 is formed between the substrate 1010 and the fourth film in order to reduce the parasitic capacitance of the condenser microphone 1003.

The plate 1330 has a through-hole pattern 1334 in which a plurality of holes 1036 are aligned in plural lines along the step portion 1332 with an equal distance P31 therebetween. A distance P32 between adjacent lines (along which the holes 1036 are aligned respectively) is determined in such a way that none of the holes 1036 are positioned at the step portion 1332. That is, the holes 1036 are uniformly formed and positioned in the planar portion 1333 of the plate 1330 by avoiding the step portion 1332.

A pad 1301 is formed using the second film and is connected to the diaphragm 1320. A pad 1302 is formed using the second film and is connected to the guard electrodes 1300. A pad 1303 is formed using the fourth film and is connected to the plate 1330.

Next, a detecting portion of the condenser microphone 1003 will be described with reference to FIG. 19B. The guard electrode 1300 is connected to an output terminal of the operation amplifier 1100. Specifically, a lead 1110 connected to the output terminal of the operational amplifier 1100 is connected to the guard electrode 1300. The constitution of the detecting portion of the condenser microphone 1003 is substantially identical to the constitution of the detecting portion of the condenser microphone 1001 except that an amplification factor of the operational amplifier 1100 is set to “1”.

Next, the operation of the condenser microphone 1003 will be described. Since the amplification factor of the operational amplifier 1100 is set to “1”, both of the guard electrode 1300 and the plate 1330 are set to substantially the same potential, whereby substantially no parasitic capacitance is formed between the guard electrode 1300 and the plate 1330. On the other hand, since the capacity formed between the guard electrode 1300 and the substrate 1010 lies between the operational amplifier 1100 and the bias voltage source, it does not substantially influence the sensitivity of the condenser microphone 1003. That is, it is possible to reduce the parasitic capacitance of the condenser microphone 1003.

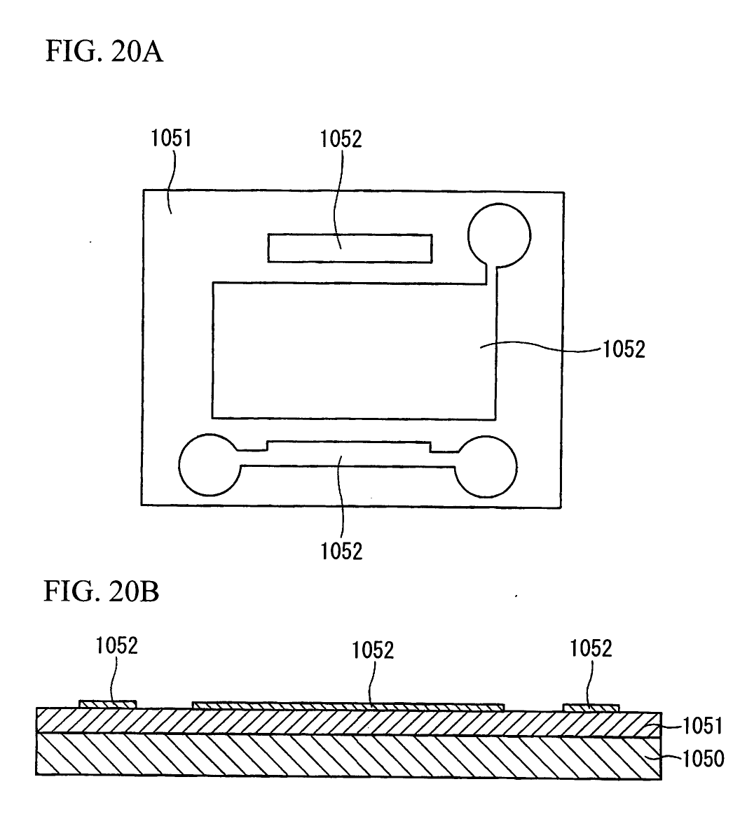

Next, a manufacturing method of the condenser microphone 1003 will be described with reference to FIGS. 20A and 20B.

First, as shown in FIGS. 20A and 20B, the first film 1051 and the second film 1052 are deposited on the wafer 1050. Similar to the manufacturing method of the condenser microphone 1001, the first film 1051 and the second film 1052 are formed by way of plasma CVD or decompression CVD. Then, the second film 1052 is subjected to etching so as to form the square-shaped second film 1052 (forming the diaphragm 1320), the guard electrode 1300, and the pads 1301 and 1302 (see FIGS. 19A and 19B).

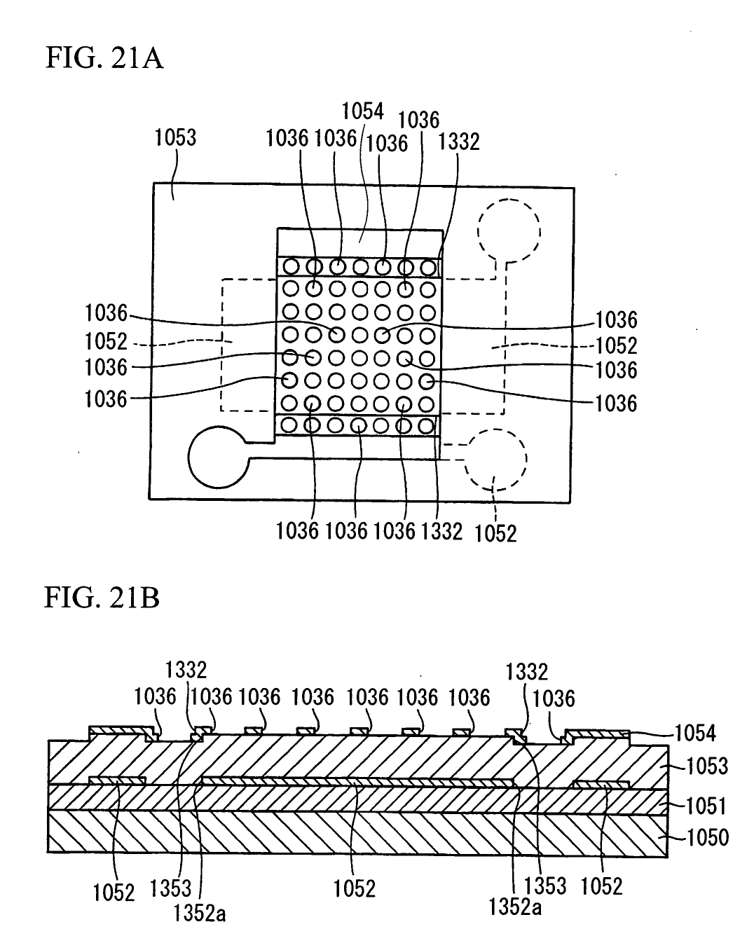

Next, as shown in FIGS. 21A and 21B, the third film 1053 is deposited on the first film 1051 and the second film 1052. Similar to the manufacturing method of the condenser microphone 1001, the third film 1053 is formed by way of plasma CVD. A step portion 1353 whose shape substantially matches the shape of an edge 1352a of the second film 1052 is formed in the third film 1053.

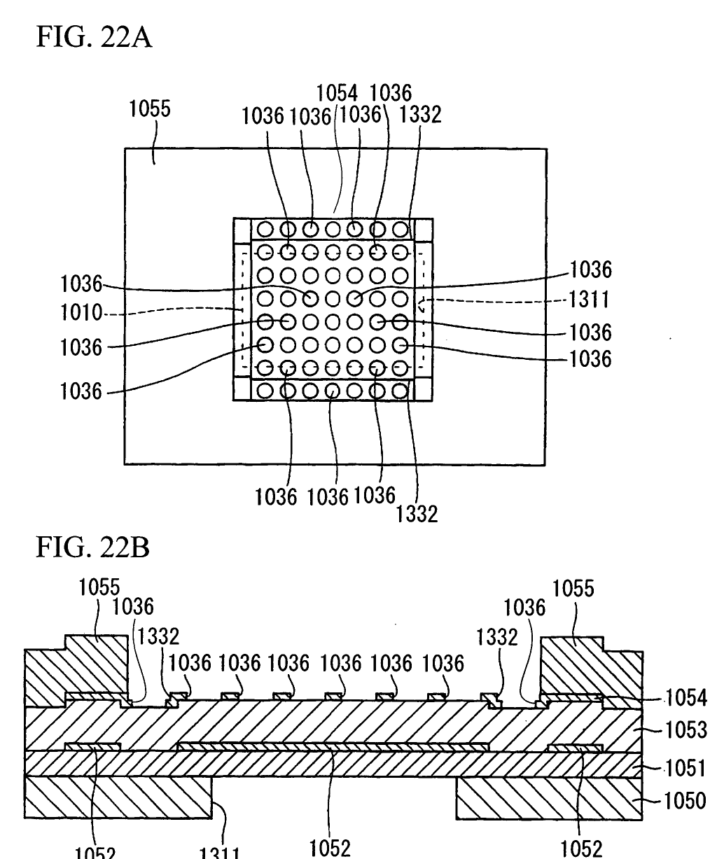

Next, as shown in FIGS. 22A and 22B, the square-shaped cavity 1311 is formed in the wafer 1050 so as to suit the three-dimensional crossing area between the diaphragm 1320 and the plate 1330. Then, similar to the manufacturing method of the condenser microphone 1001, the first film 1051 and the third film 1053 are selectively removed by use of a resist pattern for exposing the proximity of the three-dimensional crossing area between the diaphragm 1320 and the plate 1330. Thereafter, the foregoing steps are performed so as to completely produce the condenser microphone 1003.

(c) Third Variation

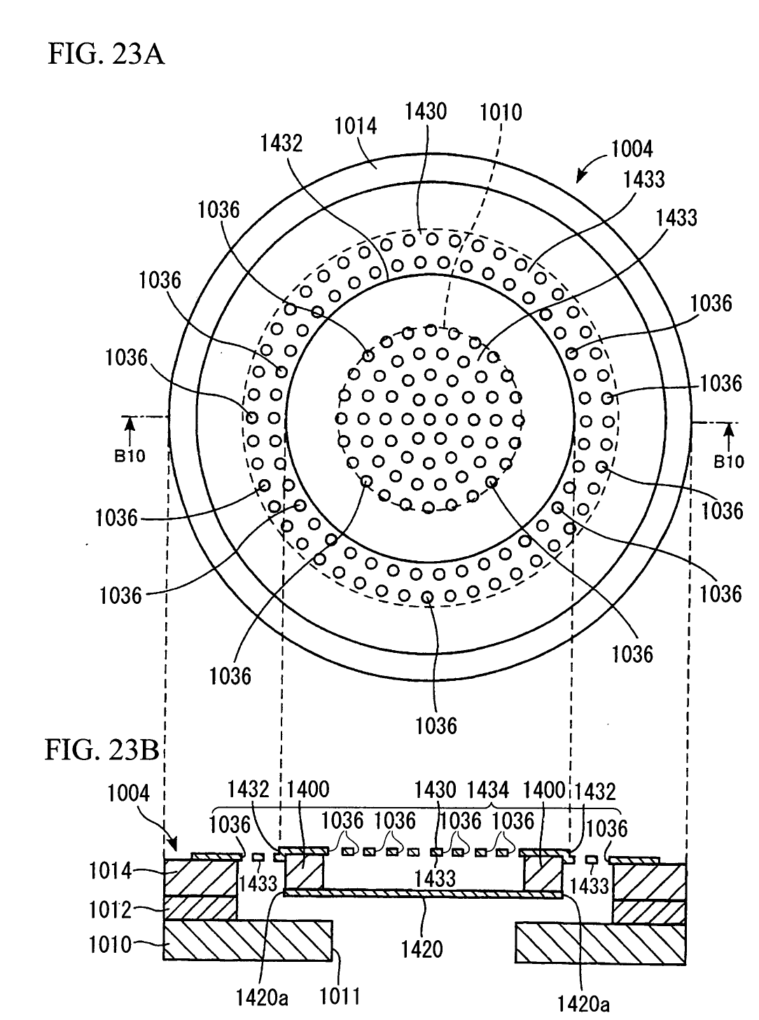

A condenser microphone 1004 according to a third variation of the second embodiment will be described with reference to FIGS. 23A and 23B. The condenser microphone 1004 is constituted of a diaphragm 1420 and a plate 1430, which differ from the diaphragm 1020 and the plate 1030 of the condenser microphone 1001. The diaphragm 1420, which is formed using a second film, is supported by the plate 1430 via a ring-shaped spacer 1400, which is formed using a third film. The diaphragm 1420 is isolated from other films and is positioned above the cavity 1011. The lower end of the spacer 1400 is fixed to the periphery of the diaphragm 1420, and the upper end of the spacer 1400 is fixed to the intermediate portion of the plate 1430.

The plate 1430 is formed using a fourth film and is constituted of a step portion 1432 and a planar portion 1433. The height difference of the step portion 1432 depends upon an edge 1420a of the diaphragm 1420, wherein the step portion 1432 has a circular shape elongated along the edge 1420a of the diaphragm 1420. The planar portion 1433 is continuously formed on both sides of the step portion 1432. A plurality of holes 1036 are formed in the planar portion 1433 of the plate 1430 by avoiding the step portion 1432 and the prescribed portion of the plate 1430 fixed to the spacer 1400.

The condenser microphone 1004 includes a detecting portion, which is substantially identical to the detecting portion of the condenser microphone 1001; hence, the description thereof will be omitted.

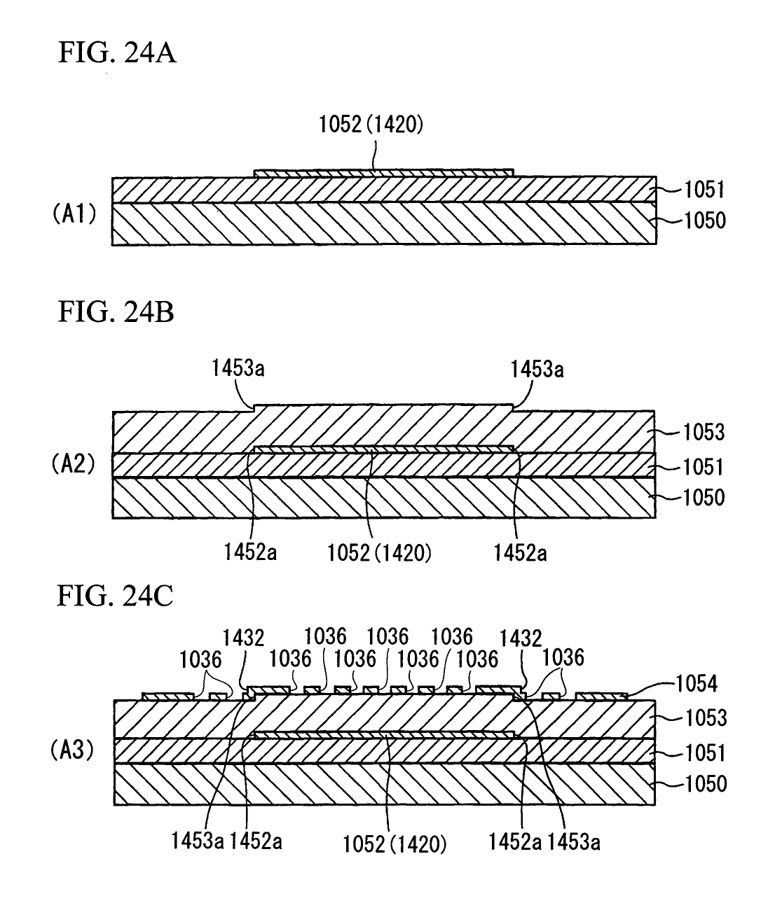

Next, a manufacturing method of the condenser microphone 1004 will be described with reference to FIGS. 24A to 24C.

First, as shown in FIG. 24A, the first film 1051 and the second film 1052 are deposited on the wafer 1050. Then, the second film 1052 is subjected to etching so as to shape the second film 1052 forming the diaphragm 1420.

Next, as shown in FIG. 24B, the third film 1053 is deposited on the first film 1051 and the second film 1052. A step portion 1453a whose shape substantially matches the shape of an edge 1452a of the second film 1052 is formed in the third film 1053.

Next, as shown in FIG. 24C, the fourth film 1054 is deposited on the third film 1053. As a result, the step 1432 whose shape substantially matches the shape of the step portion 1453a of the third film 1053 is formed in the fourth film 1054 above the edge 1452a of the second film 1052.

Next, the fourth film 1054 is subjected to etching so as to form a plurality of holes 1036 in the planar portion of the fourth film 1054, wherein none of the holes 1036 are positioned at the step portion 1432 of the fourth film 1054.

Thereafter, similar to the manufacturing method of the condenser microphone 1001, the cavity 1011 is formed in the wafer 1050 (see FIGS. 23A and 23B); then, the first film 1051 and the third film 1053 are selectively removed. Since none of the holes 1036 are formed in the intermediate portion of the fourth film 1054, the prescribed portion of the third film 1053 (see hatching in FIG. 24C), which is positioned just below the intermediate portion of the fourth film 1054, still remains so as to form the spacer 1400.

In the second embodiment and first and second variations, a plurality of holes are formed in the plate and are uniformly aligned in plural directions with equal spacing therebetween. Of course, it is possible to form a plurality of holes in a non-uniform manner. Examples will be described below.

(d) Fourth Variation

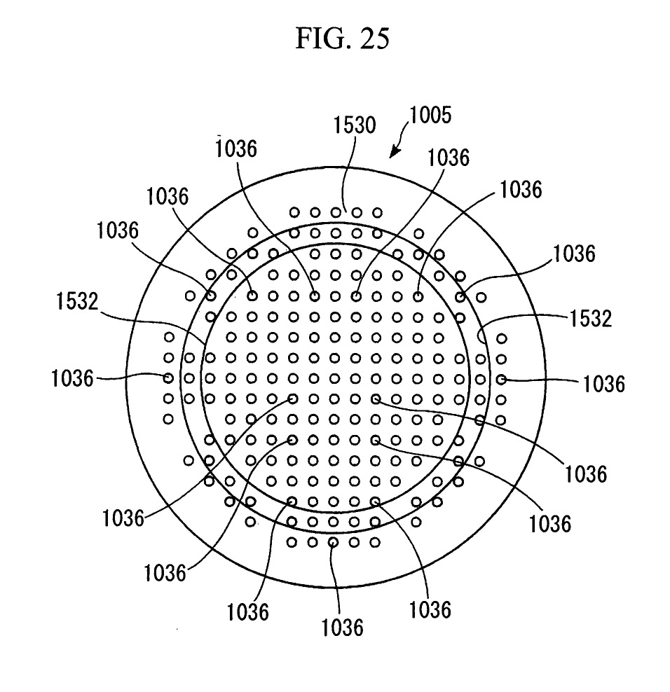

A condenser microphone 1005 according to a fourth variation of the second embodiment will be described with reference to FIG. 25. In the condenser microphone 1005, a plurality of holes 1036 are in a lattice alignment but none of the holes 1036 are positioned at a step portion 1532; that is, the holes 1036 are formed in a plate 1530 basically in a lattice alignment but none of the holes 1036 are positioned at the step portion 1532.

(e) Fifth Variation

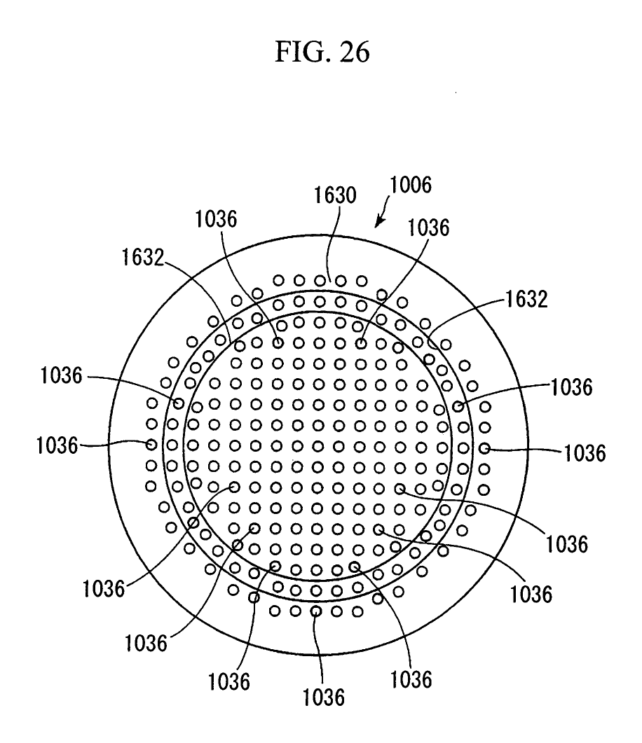

A condenser microphone 1006 according to a fifth variation of the second embodiment will be described with reference to FIG. 26. In the condenser microphone 1006, a plurality of holes 1036 are formed in a lattice alignment such that several holes 1036 are not aligned in and distanced from a step portion 1632; that is, the holes are formed in a plate 1630 basically in a lattice alignment such that several holes 1036 are distanced from the step portion 1632.

Of course, it is possible to appropriately combine the aforementioned arrangements of the holes 1036 taught in the fourth and fifth variations. In addition, it is possible to form other holes in addition to the holes 1036, which are formed in the plate in the aforementioned alignment, in order to improve the transmission of sound waves and to improve the infiltration of an etching solution.

(f) Sixth Variation

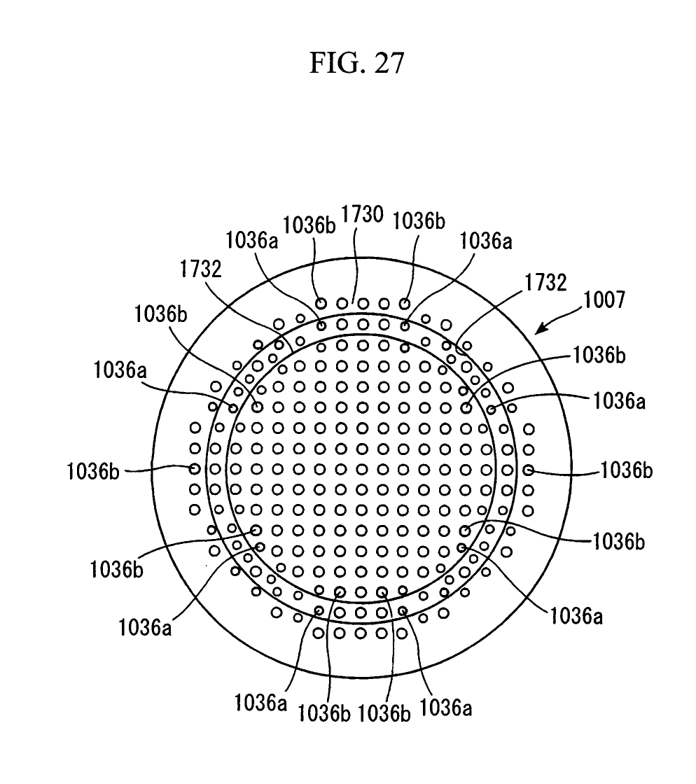

In the second embodiment and its variations, a plurality of holes each having the same opening area are formed in the plate. However, it is possible to form a plurality of holes having different opening areas in the plate. For example, in a condenser microphone 1007 according to a sixth variation of the second embodiment shown in FIG. 27, two types of holes 1036a and 1036b are formed in a plate 1730 having a step portion 1732. The holes 1036a are positioned in proximity to the step portion 1732, while the holes 1036b are distanced from the step portion 1732, wherein the opening area of the hole 1036a is smaller than the opening area of the hole 1036b. This improves the degree of freedom regarding the arrangement of the holes; hence, it is possible to appropriately arrange the holes in the plate 1730 by avoiding the step portion 1732 with ease.

In the second embodiment and its variations, a plurality of holes are formed in the planar portion of the plate by avoiding the step portion; hence, compared with another design of the plate in which holes are formed in the step portion, it is possible to improve the rigidity of the plate. This prevents the plate from being destroyed due to an external force applied to the plate during the manufacturing process and due to the occurrence of electrostatic attraction between the plate and diaphragm being electrified.

In the second embodiment and first and second variations, a plurality of holes of the plate act as a transmission passage of sound waves and an infiltration passage of an etching solution. Thus, it is possible to improve the output characteristics of the condenser microphone, and it is possible to simplify the manufacturing process and to increase the yield in manufacturing.

The second embodiment can be further modified especially in terms of the design of the plate as long as a plurality of holes are formed in the plate and are positioned to avoid the step portion.

Lastly, the present invention is not necessarily limited to the first and second embodiments; hence, it can be realized by any types of silicon microphones and condenser microphones within the scope of the invention defined by the appended claims.

What is claimed is:

1. A silicon microphone comprising:
a conductive layer whose center portion forms a diaphragm;
a plurality of supports that are arranged in a circumferential direction of the conductive layer so as to support the conductive layer; and
a corrugation that is formed in the conductive layer and that lies across imaginary lines drawn between the plurality of supports.

2. A silicon microphone comprising:
a conductive layer whose center portion forms a diaphragm;
a plurality of supports that are arranged in a circumferential direction of the conductive layer so as to support the conductive layer; and
a corrugation that is formed in the conductive layer on an imaginary line connecting the plurality of supports.

3. A silicon microphone comprising:
a conductive layer whose center portion forms a diaphragm;
a plurality of supports that are arranged in a circumferential direction of the conductive layer so as to support the conductive layer; and
a corrugation that is formed in the conductive layer on an imaginary line connecting the plurality of supports and that is arranged externally of the plurality of supports.

4. A silicon microphone according to claim 1, wherein the corrugation is formed by partially reducing a thickness of the conductive layer.

5. A silicon microphone according to claim 2, wherein the corrugation is formed by partially reducing a thickness of the conductive layer.

6. A silicon microphone according to claim 3, wherein the corrugation is formed by partially reducing a thickness of the conductive layer.

7. A silicon microphone according to claim 1, wherein instead of the corrugation, a thick portion is formed in the conductive layer by partially increasing the thickness of the conductive layer.

8. A silicon microphone according to claim 2, wherein instead of the corrugation, a thick portion is formed in the conductive layer by partially increasing the thickness of the conductive layer.

9. A silicon microphone according to claim 3, wherein instead of the corrugation, a thick portion is formed in the conductive layer by partially increasing the thickness of the conductive layer.

10. A condenser microphone comprising:
a support;
a plate having a plurality of holes and a fixed electrode, the plate being supported by the support; and
a diaphragm having a moving electrode positioned opposite to the fixed electrode, wherein the diaphragm vibrates due to sound waves applied thereto,
wherein the plate has a planar portion and a step portion, which differ from each other in thickness, wherein the planar portion is continuously formed on both sides of the step portion, and wherein the plurality of holes run through the planar portion of the plate in a thickness direction.

11. A condenser microphone according to claim 10, wherein the plurality of holes are uniformly formed and arranged in the planar portion of the plate.

12. A condenser microphone according to claim 10, wherein the plurality of holes are aligned along a plurality of lines or along a, plurality of circles by avoiding the step portion.

13. A condenser microphone according to claim 10, wherein the diaphragm has a bent portion that is bent in a thickness direction thereof in conformity with the step portion of the plate so that the bent portion is elongated along the step portion.

14. A condenser microphone according to claim 10, wherein the diaphragm has a slit so that the step portion of the plate is formed in conformity with an edge of the slit and is elongated along the edge of the recess.

15. A condenser microphone according to claim 10, wherein the step portion of the plate is formed in conformity with an edge of the diaphragm and is elongated along the edge of the diaphragm.

16. A condenser microphone according to claim 10, wherein an opening area of each of the holes formed in proximity to the step portion is smaller than an opening area of each of the holes distanced from the step portion.

17. A manufacturing method of a condenser microphone including a support, a plate, which is supported by the support and which has a fixed electrode and a plurality of holes, and a diaphragm, which has a moving electrode positioned opposite to the fixed electrode and which vibrates due to sound waves applied thereto, said manufacturing method comprising the steps of:
forming the diaphragm having a bent portion, which is bent in a thickness direction, by way of deposition;
forming a sacrifice layer covering the bent portion on the diaphragm by way of deposition;
forming the plate having a planar portion and a step portion on the sacrifice layer by way of deposition, wherein the planar portion is continuously formed on both sides of the step portion, and wherein the step portion is formed in conformity with the bent portion of the diaphragm;
etching the plate so as to form the plurality of holes running through the planar portion of the plate in a thickness direction; and
etching the sacrifice layer so as to form an air gap between the diaphragm and the plate.

18. A manufacturing method of a condenser microphone including a support, a plate, which is supported by the support and which has a fixed electrode and a plurality of holes, and a diaphragm, which has a moving electrode positioned opposite to the fixed electrode and which vibrates due to sound waves applied thereto, said manufacturing method comprising the steps of:
forming the diaphragm by way of deposition;
etching the diaphragm so as to form a slit running through the diaphragm in a thickness direction;
forming a sacrifice layer covering the slit on the diaphragm;
forming the plate having a planar portion and a step portion on the sacrifice layer by way of deposition, wherein the planar portion is continuously formed on both sides of the step portion, and wherein the step portion is formed in conformity with an edge of the slit of the diaphragm;
etching the plate so as to form the plurality of holes running through the planar potion in a thickness direction; and
etching the sacrifice layer so as to form an air gap between the diaphragm and the plate.

19. A manufacturing method of a condenser microphone including a support, a plate, which is supported by the support and which has a fixed electrode and a plurality of holes, and a diaphragm, which has a moving electrode positioned opposite to the fixed electrode and which vibrates due to sound waves applied thereto, said manufacturing method comprising the steps of:
forming the diaphragm by way of deposition;
forming a sacrifice layer covering an edge of the diaphragm by way of deposition;
forming the plate having a planar portion and a step portion on the sacrifice layer by way of deposition, wherein the planar portion is continuously formed on both sides of the step portion, and wherein the step portion is formed in conformity with the edge of the diaphragm;
etching the plate so as to form the plurality of holes running through the planar portion of the plate in a thickness direction; and
etching the sacrifice layer so as to form an air gap between the diaphragm and the plate.
